(19) United States
(12) Patent Application Publication
(10) Pub. No.: US 2024/0404555 A1
(43) Pub. Date: Dec. 5, 2024

(54) MAGNETIC RECORDING MEDIUM AND MAGNETIC RECORDING MEDIUM CARTRIDGE

(71) Applicant: Sony Group Corporation, Tokyo (JP)

(72) Inventors: Kazuo ANNO, Tokyo (JP); Takanobu IWAMA, Tokyo (JP); Hiroshi KUMAGAI, Tokyo (JP); Taeko TAKAHASHI, Tokyo (JP); Eiji NAKASHIO, Tokyo (JP)

(21) Appl. No.: 18/576,679

(22) PCT Filed: Mar. 18, 2022
(86) PCT No.: PCT/JP2022/012710

§ 371 Date: Jan. 4, 2024

(30) Foreign Application Priority Data
Aug. 6, 2021 (JP) 2021-130332

(51) Int. Cl. G11B 5/78; G11B 23/107

(52) U.S. Cl. CPC G11B 5/78; G11B 23/107

(57) ABSTRACT

Provided is a magnetic recording medium that allows for superior operational reliability while addressing still higher capacity. The magnetic recording medium includes a magnetic recording tape extending in a longitudinal direction, and a leader tape coupled thereto in the longitudinal direction. Further, a maximum step difference of a stepped part positioned closest to a coupling part between the leader tape and the magnetic recording tape, among a plurality of the stepped parts generated on the leader tape after traveling in accordance with the following conditions 1 to 3, is 34 μm or less in a thickness direction of the leader tape. Condition 1 is being in an environment of a temperature of 23° C. and a relative humidity of 45% RH, condition 2 is using a drive pursuant to a standard of LTO 9, and condition 3 is performing reciprocating traveling 140 times to record and reproduce a capacity of 18 terabytes.

### TECHNICAL FIELD

The present disclosure relates to a magnetic recording medium and a magnetic recording medium cartridge.

### BACKGROUND ART

A tape-like magnetic recording medium has been widely used to store electronic data. A magnetic recording medium has heretofore been proposed in which a leader tape is coupled to a leading end of a magnetic recording tape that records information (see, e.g., PTL 1).

### CITATION LIST

### Patent Literature

PTL 1: Japanese Unexamined Patent Application Publication No. 2005-310354

### SUMMARY OF THE INVENTION

Incidentally, a magnetic recording medium is expected to have a still higher capacity in the future.

It is therefore desirable to provide a magnetic recording medium that makes it possible to obtain superior operational reliability while addressing still higher capacity.

A magnetic recording medium according to an embodiment of the present disclosure includes a magnetic recording tape extending in a longitudinal direction, and a leader tape coupled to the magnetic recording tape in the longitudinal direction. Further, a maximum step difference of a stepped part at a position closest to a coupling part between the leader tape and the magnetic recording tape, among a plurality of the stepped parts generated on the leader tape after traveling in accordance with the following conditions 1 to 3, is 34 μm or less in a thickness direction of the leader tape. Note that condition 1 is being in an environment of a temperature of 23° C. and a relative humidity of 45% RH, condition 2 is using a drive pursuant to a standard of LTO 9, and condition 3 is performing reciprocating traveling 140 times to record and reproduce a capacity of 18 terabytes.

### BRIEF DESCRIPTION OF THE DRAWINGS

FIG. 1 is a schematic view of a configuration example of a magnetic recording cartridge according to a first embodiment of the present disclosure.

FIG. 2 is an enlarged cross-sectional view of a magnetic recording tape of a magnetic recording medium illustrated in FIG. 1.

FIG. 3 is a schematic cross-sectional view of a cross-sectional structure of an ε-iron oxide particle included in a magnetic layer illustrated in FIG. 2.

FIG. 4 is a graph illustrating an example of an SFD curve of the magnetic recording tape illustrated in FIG. 2.

FIG. 5 is a schematic outline view of an appearance of a measuring apparatus used for measuring a width of the magnetic recording medium.

FIG. 6 is an enlarged cross-sectional view of a leader tape of the magnetic recording medium illustrated in FIG. 1.

FIG. 7A is an enlarged schematic plan view of a coupling part between the leader tape and the magnetic recording tape illustrated in FIG. 1.

FIG. 7B is an enlarged schematic cross-sectional view of the coupling part between the leader tape and the magnetic recording tape illustrated in FIG. 1.

FIG. 8 is a schematic explanatory diagram illustrating an irregular shape of a surface of the leader tape.

FIG. 9 is an enlarged schematic view of a portion of a reel of the magnetic recording cartridge illustrated in FIG. 1.

FIG. 10 is an explanatory diagram that describes a method of measuring the maximum step difference of the leader tape illustrated in FIG. 1.

FIG. 11 is a schematic view of a configuration example of a recording/reproducing apparatus provided with the magnetic recording cartridge in FIG. 1.

FIG. 12 is a cross-sectional view of an ε-iron oxide particle according to a modification example of the first embodiment.

FIG. 13 is a cross-sectional view of a magnetic recording medium according to another modification example of the first embodiment.

FIG. 14 is a cross-sectional view of a magnetic recording medium according to a second embodiment of the present disclosure.

FIG. 15 is a schematic view of a configuration example of a sputtering apparatus used for manufacturing the magnetic recording medium illustrated in FIG. 14.

FIG. 16A is an explanatory diagram of a method of measuring PES using the recording/reproducing apparatus in FIG. 11.

FIG. 16B is an outline view of a head unit of the recording/reproducing apparatus in FIG. 11.

FIG. 16C is an explanatory diagram of a method of measuring a servo trace line.

### MODES FOR CARRYING OUT THE INVENTION

Hereinafter, some embodiments of the present disclosure are described in detail with reference to the drawings. It is to be noted that the embodiments described below are those illustrating representative embodiments of the present technology and the present technology is not limited to the following embodiments.

It is to be noted that description is given in the following order.

### 0. Overview of Present Technology

1. First Embodiment (An example of a magnetic recording cartridge including a magnetic recording medium)

1-1. Configuration of Magnetic Recording Cartridge

1-2. Configuration of Magnetic Recording Medium

1-3. Method of Measuring Step Difference of Leader Tape

1-4. Method of Manufacturing Magnetic Recording Medium

1-5. Recording/Reproducing Apparatus

1-6. Effects

1-7. Modification Examples

2. Second Embodiment (An example of a magnetic recording cartridge including a sputtered magnetic recording medium)

2-1. Configuration of Magnetic Recording Cartridge

2-2. Configuration of Magnetic Recording Medium

2-3. Configuration of Sputtering Apparatus

2-4. Method of Manufacturing Magnetic Recording Medium

2-5. Effects

2-6. Modification Example

### 3. Examples

### 1. OVERVIEW OF PRESENT TECHNOLOGY

First, a description is given of the history leading to the creation of the technology of the present disclosure. In recent years, it is required to further increase a recording capacity per magnetic recording cartridge that has been utilized for computer data storage, or the like. In order to increase the recording capacity, for example, a track width in a tape-like magnetic recording medium to be accommodated in a magnetic recording cartridge is narrowed, or a distance between adjacent tracks is narrowed. However, when the track width is narrowed or the distance between the adjacent tracks is narrowed, a dimensional change amount tolerable by the magnetic recording medium itself due to environmental factors such as temperature/humidity changes becomes increasingly smaller. That is, due to the variation in the width of the magnetic recording medium, the magnetic recording/reproducing apparatus may not be able to accurately read data recorded in the magnetic recording medium, which may possibly cause a readout error. Therefore, there is a possibility that the operational reliability of the magnetic recording/reproducing apparatus and the reliability of the magnetic recording medium used for the magnetic recording/reproducing apparatus may be impaired.

Therefore, the present applicant has proposed a magnetic recording/reproducing apparatus that makes it possible to keep a width of a tape-like magnetic recording medium substantially constant by adjusting a tension of the magnetic recording medium in a longitudinal direction as well as a magnetic recording medium suitable therefor. In the magnetic recording/reproducing apparatus, for example, a dimension of the magnetic recording medium in a width direction or a change in the dimension is detected, and the tension to be applied to the magnetic recording medium in the longitudinal direction is adjusted on the basis of a result of the detection. In this manner, applying a predetermined tension to the magnetic recording medium makes it possible to keep the width of the magnetic recording medium substantially constant and thus to ensure the reliability of each of the magnetic recording medium and the magnetic recording/reproducing apparatus.

However, applying a predetermined tension to the magnetic recording medium may more remarkably exhibit bending, depression, or the like occurring on a surface of the magnetic recording medium, in some cases. For example, in the magnetic recording medium, a leader tape is coupled to a leading end of a magnetic recording tape on which information is recorded. Typically, the end of the leader tape is provided with a leader pin to be attached to a wind-up reel (hereinafter, referred to as a take-up reel) on a side of a tape drive. The take-up reel is provided with a cutout portion, and a part to be coupled to the leader pin is fit into the cutout portion. When the part to be coupled to the leader pin is fitted into the cutout portion, a slight step difference is generated in a wind-up portion of the take-up reel. Accordingly, for example, when the magnetic recording medium is stored in a wound-up state at a high tension in the take-up reel, the step difference of the take-up reel may be transferred onto the surface of the magnetic recording tape, thus causing bending or depression to occur on the surface of the magnetic recording medium, in some cases.

In view of such circumferences, the present applicant thus proposes a magnetic recording medium that makes it possible to achieve superior recording and reproducing operations while maintaining high recording density.

### 1. FIRST EMBODIMENT (AN EXAMPLE OF A MAGNETIC RECORDING CARTRIDGE INCLUDING A COATED MAGNETIC RECORDING MEDIUM)

### [1-1. Configuration of Magnetic Recording Cartridge 1]

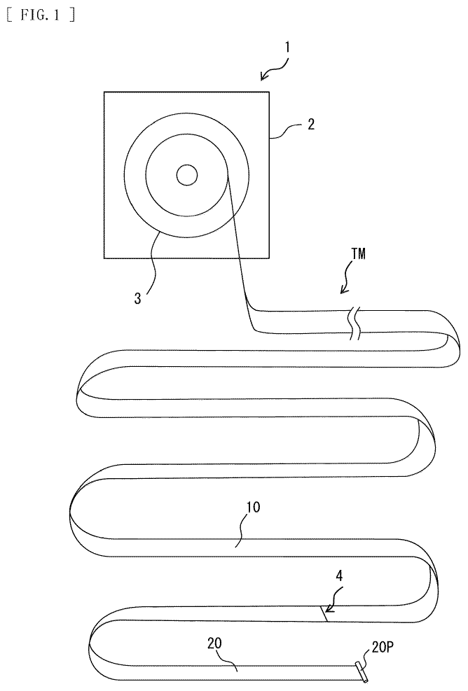

First, a description is given, with reference to FIG. 1, of a configuration of a magnetic recording cartridge 1 according to a first embodiment of the present disclosure. FIG. 1 is a schematic view of an example of the magnetic recording cartridge 1. The magnetic recording cartridge 1 includes a cartridge case 2 and a cartridge reel 3 provided therein. A tape-like magnetic recording medium TM is wound around the cartridge reel 3. When performing recording on the magnetic recording medium TM and when performing reproducing from the magnetic recording medium TM, the magnetic recording medium TM travels along its own longitudinal direction. The magnetic recording medium TM is preferably used in a recording/reproducing apparatus including a ring-type head as a recording head, for example.

### [1-2. Configuration of Magnetic Recording Medium TM]

FIG. 1 schematically illustrates a state in which the vicinity of the end of an outermost layer portion of the magnetic recording medium TM wound around the cartridge reel 3 is drawn out from the cartridge case 2. The tape-like magnetic recording medium TM includes a magnetic recording tape 10 and a leader tape 20 extending in a longitudinal direction of the magnetic recording medium TM. The magnetic recording tape 10 and the leader tape 20 are coupled to each other in the longitudinal direction of the magnetic recording medium TM.

The magnetic recording tape 10 is a portion where various types of information can be magnetically recorded. The leader tape 20 is a portion that is to be wound around the cartridge reel 3 after the magnetic recording tape 10, and has strength higher than strength of the magnetic recording tape 10, for example. The end of the leader tape 20 is provided with a leader pin 20P. When the magnetic recording cartridge 1 is mounted on a recording/reproducing apparatus 30 described later, the leader tape 20 is drawn out from the magnetic recording cartridge 1, and the leader pin 20P is attached to a take-up reel 32 (described later) provided in the recording/reproducing apparatus 30. It is to be noted that the recording/reproducing apparatus 30 is a drive (recording/reproducing apparatus) pursuant to the standard of LTO 9.

### (Magnetic Recording Tape 10)

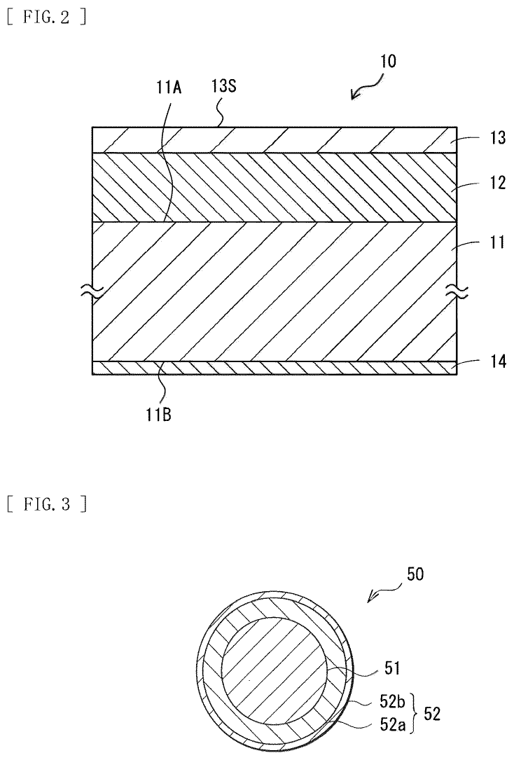

FIG. 2 schematically illustrates a cross-sectional configuration example of the magnetic recording tape 10. As illustrated in FIG. 2, the magnetic recording tape 10 has a stacked structure in which a plurality of layers are stacked. Specifically, the magnetic recording tape 10 includes an elongated tape-like substrate 11, an underlayer 12 provided on a main surface 11A of the substrate 11, a magnetic layer 13 provided on the underlayer 12, and a back layer 14 provided on a main surface 11B, of the substrate 11, on a side opposite to a main surface 21A. When the magnetic recording medium TM travels, a surface of a magnetic head slides on a surface 13S of the magnetic layer 13. It is to be noted that the underlayer 12 and the back layer 14 are provided as needed, or may be omitted.

### (Substrate 11)

The substrate 11 is a non-magnetic support that supports the underlayer 12 and the magnetic layer 13. The substrate 11 has an elongated film shape. The upper limit value of an average thickness of the substrate 11 is preferably 4.4 μm or less, and more preferably 4.2 μm or less. When the upper limit value of the average thickness of the substrate 11 is 4.2 μm or less, it is possible to increase a recordable recording capacity of one magnetic recording cartridge 1, as compared with a common magnetic recording medium. For example, it is possible to increase a recordable recording capacity of the one magnetic recording cartridge 1 having an LTO shape to 15 TB or more. The lower limit value of the average thickness of the substrate 11 is preferably 3 μm or more, more preferably 3.2 μm or more. When the lower limit value of the average thickness of the substrate 11 is 3 μm or more, it is possible to suppress a decrease in strength of the substrate 11.

The average thickness of the substrate 11 is determined as follows. First, the magnetic recording tape 10 having a width of ½ inches is prepared, and cut into a length of 250 mm to produce a sample. Subsequently, the layers of the sample except the substrate 11, i.e., the underlayer 12, the magnetic layer 13, and the back layer 14 are removed with a solvent, such as MEK (methyl ethyl ketone) or dilute hydrochloric acid. Next, a measuring apparatus, Laser Hologauge (LGH-110C) manufactured by Mitutoyo Corporation, is used to measure the thickness of the substrate 11 as the sample at five points or more. Thereafter, these measurement values are simply averaged (arithmetically averaged) to calculate the average thickness of the substrate 11. It is to be noted that the measurement positions are randomly selected on the sample.

The substrate 11 includes polyesters as a primary constituent, for example. Alternatively, the substrate 11 may include PEEK (polyether ether ketone) as the primary constituent. The substrate 11 may include at least one of polyolefins, cellulose derivatives, vinyl-based resins, or other polymeric resins, in addition to polyesters or PEEK. In a case where the substrate 11 includes two or more of the materials described above, the two or more materials may be mixed, copolymerized, or stacked.

The polyesters included in the substrate 11 include, for example, at least one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), or polyethylene bisphenoxycarboxylate.

The polyolefins included in the substrate 11 include, for example, at least one of PE (polyethylene) or PP (polypropylene). The cellulose derivatives include, for example, at least one of cellulose diacetate, cellulose triacetate, CAB (cellulose acetate butyrate), or CAP (cellulose acetate propionate). The vinyl-based resins include, for example, at least one of PVC (polyvinyl chloride) or PVDC (polyvinylidene chloride).

Other polymeric resins included in the substrate 11 include, for example, at least one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, for example, Zylon (Registered Trademark)), polyether, PEK (polyether ketone), polyether-ester, PES (polyether sulfone), PEI (polyetherimide), PSF (polysulfone), PPS (polyphenylene sulfide), PC (polycarbonate), PAR (polyarylate), or PU (polyurethane).

### (Magnetic Layer 13)

The magnetic layer 13 is a recording layer to record signals. The magnetic layer 13 includes, for example, magnetic powders, a binder, and a lubricant. The magnetic layer 13 may further include an additive, such as electrically-conductive particles, an abrasive, and a rust inhibitor, as needed.

The surface 13S of the magnetic layer 13 has an arithmetic mean roughness Ra of 2.5 nm or less, preferably 2.2 nm or less, and more preferably 1.9 nm or less. When the arithmetic mean roughness Ra is 2.5 nm or less, it is possible to obtain superior electromagnetic conversion characteristics. The lower limit value of the arithmetic mean roughness Ra of the surface 13S of the magnetic layer 13 may be preferably 0.4 nm or more, more preferably 0.6 nm or more, and still more preferably 0.8 nm or more. When the lower limit value of the arithmetic mean roughness Ra of the surface 13S of the magnetic layer 13 is 1.0 nm or more, it is possible to suppress a decrease in traveling performance due to an increase in friction.

The arithmetic mean roughness Ra of the surface 13S is determined as follows. First, the surface of the magnetic layer 13 is observed using an AFM (Atomic Force Microscope) to obtain an AFM image of 40 μm×40 μm. Nano Scope IIIa D3100, manufactured by Digital Instruments Co., Ltd., is used as the AFM, and a cantilever made of silicon single crystal is used. The measurement is performed by tuning a tapping frequency within a range from 200 Hz to 400 Hz. The cantilever may be, for example, “SPM-probe NCH normal-type PointProbe L (cantilever length)=125 μm” manufactured by NanoWorld AG. Next, the AFM image is divided into 512×512 (=262,144) measurement points. The heights Z (i) (i: measurement point number, i=1 to 262, 144) are measured at each of the measurement points, and the heights Z (i) of the measurement points are simply averaged (arithmetically averaged) to obtain an average height (average plane) Zave(=(Z(1)+Z(2)+ . . . +Z (262,144))/262,144). Subsequently, a standard deviation Z″(i)(=|Z(i)-Zave|) of each of the measuring points from the average center line is obtained, and the arithmetic mean roughness Ra [nm](=(Z″(1)+Z″(2)+ . . . +Z″ (262,144)/262,144) is calculated. In this case, data processed through image processing, such as a filtering processing performed by Flatten order 2 and planefit order 3 XY, is used. It is to be noted that, when determining the arithmetic mean roughness Ra of the surface 13S, measurement samples are collected one by one at three locations of different positions in a range of 10 m or less from a coupling part 4 along the longitudinal direction, of the magnetic recording tape 10 of the magnetic recording medium TM to be accommodated in the magnetic recording cartridge 1. The collected three measurement samples are observed by the AFM described above. For each of the measurement samples, the arithmetic mean roughness Ra of the surface 13S is calculated as described above, and calculated values of all of the three measurement samples are simply averaged to thereby obtain the arithmetic mean roughness Ra of the surface 13S of the entire magnetic recording tape 10.

From the viewpoint of ensuring a high recording capacity, the magnetic layer 13 is configured to be able to record data to allow the minimum value of a distance L between magnetization reversals to be preferably 48 nm or less, more preferably 44 nm or less, and still more preferably 40 nm or less. The lower limit value of the minimum value of the distance L between the magnetization reversals is preferably 20 nm or more from the viewpoint of the magnetic particle size.

The upper limit value of the average thickness of the magnetic layer 13 is preferably 90 nm or less, particularly preferably 80 nm or less, more preferably 70 nm or less, and still more preferably 50 nm or less. In a case where the upper limit value of the average thickness of the magnetic layer 13 is 90 nm or less and where a ring-type head is used as the recording head, it is possible to record magnetizations uniformly in the thickness direction of the magnetic layer 13, and thus to improve the electromagnetic conversion characteristics.

The lower limit value of the average thickness of the magnetic layer 13 is preferably 35 nm or more. In a case where the upper limit value of the average thickness of the magnetic layer 13 is 35 nm or more and where an MR-type head is used as a reproducing head, it is possible to secure the output, and thus to improve the electromagnetic conversion characteristics.

The average thickness of the magnetic layer 13 is determined as follows.

First, the magnetic recording tape 10 is processed through a FIB (focused ion beam) method, or the like into a thin piece. In a case where the FIB method is used, the formation of the carbon films and the tungsten thin film serving as the protective film is performed as a pretreatment for observing a cross-sectional TEM image described later. The carbon films are formed on a surface of the magnetic recording tape 10 on the side of the magnetic layer and a surface of the magnetic recording tape 10 on a side of the back layer, by a deposition method. The tungsten thin film is then further formed on the surface on the side of the magnetic layer by a deposition method or a sputtering method. The thinning is performed along a length direction (longitudinal direction) of the magnetic recording tape 10. That is, the thinning forms a cross-section parallel to both the longitudinal direction and the thickness direction of the magnetic recording tape 10. The cross-section of the obtained thin sample piece is observed using a transmission electron microscope (TEM) under the following conditions to obtain a TEM image. It is to be noted that magnification and acceleration voltage may be appropriately adjusted depending on the type of the apparatus.
Apparatus: TEM (H9000NAR manufactured by Hitachi, Ltd.)
Acceleration voltage: 300 kV
Magnification: 100,000 times

Next, the obtained TEM image is used to measure the thickness of the magnetic layer 13 at at least ten positions or more along the longitudinal direction of the magnetic recording tape 10. The obtained measurement values are simply averaged (arithmetically averaged) to obtain an average value, which is defined as the average thickness of the magnetic layer 13. It is to be noted that the measurement positions are randomly selected on the sample piece.

### (Magnetic Powder)

The magnetic powders contain, for example, nanoparticle powders containing ε-iron oxide (hereinafter referred to as “ε-iron oxide particle”). Even when the ε-iron oxide particles are fine particles, it is possible to obtain high coercivity. It is preferable that the ε-iron oxide contained in the ε-iron oxide particle is preferentially crystallographically oriented in the thickness direction (vertical direction) of the magnetic recording tape 10.

FIG. 3 is a schematic cross-sectional view of an example of a cross-sectional structure of an ε-iron oxide particle 50 contained in the magnetic layer 13. As illustrated in FIG. 3, the ε-iron oxide particle 50 has a spherical or substantially spherical shape, or a cubic or substantially cubic shape. Because the ε-iron oxide particle 50 has a shape as described above, in a case where the ε-iron oxide particles 50 are used as magnetic particles, it is possible to reduce the contact area between the particles in the thickness direction of the magnetic recording tape 10, and thus to suppress aggregation of the particles, as compared with the case of using hexagonal plate-shaped barium ferrite particles as the magnetic particles. Therefore, it is possible to obtain enhanced dispersibility of the magnetic powders and a more favorable SNR (Signal-to-Noise Ratio).

The ε-iron oxide particle 50 has a core-shell structure, for example. Specifically, as illustrated in FIG. 3, the ε-iron oxide particle 50 includes a core part 51 and a shell part 52 having a two-layer structure provided around the core part 51. The shell part 52 of the two-layer structure includes a first shell part 52a provided on the core part 51, and a second shell part 52b provided on the first shell part 52a.

The core part 51 of the ε-iron oxide particle 50 contains ε-iron oxide. The ε-iron oxide contained in the core part 51 includes preferably ε—Fe₂O₃ crystals as a main phase, more preferably a single phase of ε—Fe₂O₃.

The first shell part 52a covers at least a portion of the periphery of the core part 51. Specifically, the first shell part 52a may partially cover the periphery of the core part 51 or may cover the entire periphery of the core part 51. From the viewpoint of ensuring sufficient exchange coupling between the core part 51 and the first shell part 52a and improving magnetic characteristics, it is preferable to cover the entire surface of the core part 51.

The first shell part 52a is a so-called soft magnetic layer, and contains, for example, a soft magnetic material such as α-Fe, Ni—Fe alloy or Fe—Si—Al alloy. The α-Fe may be obtained by reducing the ε-iron oxide contained in the core part 51.

The second shell part 52b is an oxide coating serving as an antioxidant layer. The second shell part 52b contains α-iron oxide, aluminum oxide, or silicon oxide. The α-iron oxide includes, for example, at least one iron oxide of Fe₃O₄, Fe₂O₃, or FeO. In a case where the first shell part 52a contains α-Fe (soft magnetic material), the α-iron oxide may be obtained by oxidizing the α-Fe contained in the first shell part 52a.

The ε-iron oxide particles 50 including the first shell part 52a as described above makes it possible to adjust coercivity Hc of the entire ε-iron oxide particle (core shell particle) 20 to the coercivity Hc suitable for recording while maintaining the coercivity Hc of the core part 51 alone at a large value in order to ensure thermal stability. In addition, the ε-iron oxide particle 50 including the second shell part 52b as described above makes it possible to suppress deterioration of the characteristics of the ε-iron oxide particle 50 due to rust or the like generated on the particle surface as a result of exposure of the ε-iron oxide particles 50 to air during or before the manufacturing step of the magnetic recording tape 10. Therefore, it is possible to suppress the characteristic deterioration of the magnetic recording tape 10 by covering the first shell part 52a with the second shell part 52b.

The average particle size (average maximum particle size) of the magnetic powders is preferably 25 nm or less, more preferably 8 nm or more and 22 nm or less, and still more preferably 12 nm or more and 22 nm or less. In the magnetic recording tape 10, a region having a size of half the recording wavelength corresponds to an actual magnetization region. Therefore, it is possible to obtain a favorable S/N by setting the average particle size of the magnetic powders to half or less of the shortest recording wavelength. Therefore, when the average particle size of the magnetic powders is 22 nm or less, it is possible to obtain favorable electromagnetic conversion characteristics (e.g., SNR) of the magnetic recording tape 10 having a high recording density (e.g., the magnetic recording tape 10 configured to be able to record signals at the shortest recording wavelength of 50 nm or less). Meanwhile, when the average particle size of the magnetic powders is 8 nm or more, it is possible to further improve the dispersibility of the magnetic powders, and thus to obtain much superior electromagnetic conversion characteristics (e.g., SNR).

The average aspect ratio of the magnetic powders is preferably 1 or more and 3.0 or less, more preferably 1 or more and 2.8 or less, and still more preferably 1 or more and 1.8 or less. When the average aspect ratio of the magnetic powders is within the range from 1 to 3.0 inclusive, it is possible to suppress aggregation of the magnetic powders and reduce resistance applied to the magnetic powders when the magnetic powders are perpendicularly oriented in the step of forming the magnetic layer 13. Therefore, it is possible to improve the vertical orientation of the magnetic powders.

The average particle size and the average aspect ratio of the magnetic powders as described above are determined as follows. First, the magnetic recording tape 10 to be measured is processed through the FIB (Focused Ion Beam) method, or the like into a thin piece. The thinning is performed along the length direction (longitudinal direction) of the magnetic tape. That is, the thinning forms a cross-section parallel to both the longitudinal direction and the thickness direction of the magnetic recording tape 10. The cross-section of the obtained thin sample piece is observed using a transmission electron microscope (H-9500 manufactured by Hitachi High-Technologies) at an acceleration voltage of 200 kV and total magnification of 500,000 times, to allow the magnetic layer 13 to be entirely included in the thickness direction of the magnetic layer 13. A TEM photograph is then captured. Next, 50 particles are randomly selected from the captured TEM photograph, and a major axis length DL and a minor axis length DS of each particle are measured. Here, the major axis length DL refers to the maximum distance between any two parallel lines drawn from any angles so as to contact the contour of each particle (so-called maximum Feret diameter). Meanwhile, the minor axis length DS refers to the maximum length of the particle in the direction orthogonal to the major axis length DL of the particle.

Subsequently, the major axis lengths DL of the 50 measured particles are simply averaged (arithmetically averaged) to determine an average major axis length DLave. The average major axis length DLave determined in this manner is defined as the average particle size of the magnetic powders. In addition, the minor axis lengths DS of the 50 measured particles are simply averaged (arithmetically averaged) to determine an average minor axis length DSave. Then, an average aspect ratio (DLave/DSave) of the powders is determined from the average major axis length DLave and the average minor axis length DSave.

The average particle volume of the magnetic powders is, for example, 400 nm³ or more and 1800 nm³ or less. Further, the average particle volume of the magnetic powders is preferably 400 nm³ or more and 1500 nm³ or less, and more preferably 400 nm³ or more and 1200 nm³ or less.

In a case where the ε-iron oxide particle 50 has a spherical or substantially spherical shape, the average particle volume of the magnetic powders is determined as follows. First, the average major axis length DLave is determined in the same manner as the above-described calculation method of the average particle size of the magnetic powders. Next, an average particle volume V of the magnetic powders is determined using the following expression.

V=(π/6)×(DLave)³

### (Binder)

It is preferable to use, as the binder, a resin having a structure in which a crosslinking reaction is imparted to a polyurethane-based resin, a vinyl chloride-based resin, or the like. However, the binder is not limited thereto, and other resins may be appropriately blended depending on required physical properties and the like of the magnetic recording tape 10. Typically, the resin to be blended is not particularly limited as long as being a resin commonly used in the magnetic recording tape 10 of a coating type.

Examples of the binder include polyvinyl chloride, polyvinyl acetate, vinyl chloride-vinyl acetate copolymer, vinyl chloride-vinylidene chloride copolymer, vinyl chloride-acrylonitrile copolymer, acrylic acid ester-acrylonitrile copolymer, acrylic acid ester-vinyl chloride-vinylidene chloride copolymer, vinyl chloride-acrylonitrile copolymer, acrylic acid ester-acrylonitrile copolymer, acrylic acid ester-vinylidene chloride copolymer, methacrylic acid ester-vinylidene chloride copolymer, methacrylic acid ester-vinyl chloride copolymer, methacrylic acid ester-ethylene copolymer, polyvinyl fluoride, vinylidene chloride-acrylonitrile copolymer, acrylonitrile-butadiene copolymer, polyamide resin, polyvinyl butyral, cellulose derivatives (cellulose acetate butyrate, cellulose diacetate, cellulose triacetate, cellulose propionate, and nitrocellulose), styrene butadiene copolymer, polyester resin, amino resin, synthetic rubber, and the like.

In addition, examples of the thermosetting resin or the reactive resin include phenolic resin, epoxy resin, urea resin, melamine resin, alkyd resin, silicone resin, polyamine resin, urea formaldehyde resin, and the like.

In addition, a polar functional group, such as —SO₃M, —OSO₃M, —COOM, or P=O(OM)₂ may be introduced into each of the binders described above for the purpose of improving the dispersibility of the magnetic powders. Here, M in the above chemical formulae is a hydrogen atom or an alkali metal, such as lithium, potassium, or sodium.

Further, examples of the polar functional group include those of the side chain type having a terminal group of —NR1R2 or —NR1R2R3³⁰ X⁻, and those of the main chain type of >NR1R2⁺X⁻. Here, R1, R2, and R3 in the above formulae are hydrogen atoms or hydrocarbon groups, and X is a halogen element ion, such as fluorine, chlorine, bromine, or iodine, or an inorganic or organic ion. Further, other examples of the polar functional group include —OH, —SH, —CN, epoxy groups, and the like.

### (Lubricant)

The lubricant contained in the magnetic layer 13 contains, for example, fatty acid and fatty acid ester. It is preferable that the fatty acid contained in the lubricant include at least one of a compound represented by the following general formula <1> or a compound represented by the following general formula <2>, for example. In addition, it is preferable that the fatty acid ester contained in the lubricant include at least one of a compound represented by the following general formula <3> or a compound represented by the following general formula <4>. It is possible to suppress an increase in dynamic friction coefficient due to repetitive recording or reproducing on the magnetic recording tape 10 by the lubricant including two compounds of the compound represented by the general formula <1> and the compound represented by the general formula <3>; the lubricant including two compounds of the compound represented by the general formula <2> and the compound represented by the general formula <3>; the lubricant including two compounds of the compound represented by the general formula <1> and the compound represented by the general formula <4>; the lubricant including two compounds of the compound represented by the general formula <2> and the compound represented by the general formula <4>; the lubricant including three compounds of the compound represented by the general formula <1>, the compound represented by the general formula <2>, and the compound represented by the general formula <3>; the lubricant including three compounds of the compound represented by general formula <1>, the compound represented by general formula <2>, and the compound represented by the general formula <4>; the lubricant including three compounds of the compound represented by the general formula <1>, the compound represented by the general formula <3>, and the compound represented by the general formula <4>; the lubricant including three compounds of the compound represented by the general formula <2>, the compound represented by the general formula <3>, and the compound represented by the general formula <4>; or the lubricant including four compounds of the compound represented by the general formula <1>, the compound represented by the general formula <2>, the compound represented by the general formula <3>, and the compound represented by the general formula <4>. As a result, it is possible to further improve the traveling performance of the magnetic recording tape 10.

CH₃(CH₂)ₖCOOH <1>

(Note that, in the general formula <1>, k is an integer selected from the range of 14 to 22 inclusive, and more preferably the range of 14 to 18 inclusive.)

CH₃(CH₂)ₙCH═CH(CH₂)ₘCOOH <2>

(Note that, in the general formula <2>, the sum of n and m is an integer selected from the range of 12 to 20 inclusive, and more preferably the range of 14 to 18 inclusive.)

CH₃(CH₂)ₚCOO(CH₂)_{q}CH₃ <3>

(Note that, in the general formula <3>, p is an integer selected from the range of 14 to 22 inclusive, more preferably the range of 14 to 18 inclusive, and q is an integer selected from the range of 2 to 5 inclusive, more preferably the range of 2 to 4 inclusive.)

CH₃(CH₂)ₚCOO—(CH₂)_{q}CH(CH₃)₂ <4>

(Note that, in the general formula <4>, p is an integer selected from the range of 14 to 22 inclusive, and q is an integer selected from the range of 1 to 3 inclusive.)

### (Additive)

The magnetic layer 13 may further contain aluminum oxide (α, β, or γ alumina), chromium oxide, silicon oxide, diamond, garnet, emery, boron nitride, titanium carbide, silicon carbide, titanium carbide, titanium oxide (rutile or anatase-type titanium oxide), or the like as non-magnetic reinforcing particles.

### (Underlayer 12)

The underlayer 12 is a non-magnetic layer containing non-magnetic powders and a binder. The underlayer 12 may further include at least one additive of, for example, a lubricant, electrically-conductive particles, a curing agent, or a rust inhibitor, as needed. In addition, the underlayer 12 may have a multilayer structure in which a plurality of layers are stacked. The average thickness of the underlayer 12 is preferably 0.3 μm or more and 0.9 μm or less, and more preferably 0.5 μm or more and 0.7 μm or less. The average thickness of the underlayer 12 is as thin as 0.9 μm or less, which effectively decreases Young's modulus of the entire magnetic recording tape 10, as compared with the case where the thickness of the substrate 11 is reduced. This facilitates tension control over the magnetic recording tape 10. In addition, the average thickness of the underlayer 12 is set to 0.3 μm or more, thereby ensuring adhesion strength between the substrate 11 and the underlayer 12. Furthermore, it is possible to suppress variations in the thickness of the underlayer 12 and thus to prevent an increase in roughness of the surface 13S of the magnetic layer 13.

Note that the average thickness of the underlayer 12 is determined, for example, as follows. First, the magnetic recording tape 10 having a width of ½ inches is prepared, and cut into a length of 250 mm to produce a sample. Subsequently, the underlayer 12 and the magnetic layer 13 are removed from the substrate 11 of the sample of the magnetic recording tape 10. Next, the measuring apparatus, Laser Hologauge (LGH-110C) manufactured by Mitsutoyo Corporation, is used to measure the thickness of a stacked body of the underlayer 12 and the magnetic layer 13 removed from the substrate 11 at five points or more. Thereafter, these measurement values are simply averaged (arithmetically averaged) to calculate an average thickness of the stacked body of the underlayer 12 and the magnetic layer 13. It is to be noted that the measurement positions are randomly selected on the sample. Finally, an average thickness of the underlayer 12 is determined by subtracting the average thickness of the magnetic layer 13 measured using the TEM as described above from the average thickness of the stacked body.

The underlayer 12 preferably has multiple pores. The lubricant being stored in these multiple pores makes it possible to further suppress a decrease in the amount of the lubricant supplied to between the surface 13S of the magnetic layer 13 and the magnetic head even after repetitive recording or reproducing is performed (i.e., even after the magnetic head travels repeatedly while being in contact with the surface of the magnetic recording tape 10). Therefore, it is possible to further suppress an increase in the dynamic friction coefficient.

### (Non-Magnetic Powder of Underlayer 12)

The non-magnetic powders include, for example, at least one of inorganic particle powders or organic particle powders. In addition, the non-magnetic powders may include carbon powders, such as carbon black. It is to be noted that one kind of non-magnetic powders may be used alone, or two or more kinds of non-magnetic powders may be used in combination. Examples of the inorganic particles include metals, metal oxides, metal carbonates, metal sulfates, metal nitrides, metal carbides or metal sulfides, or the like. The non-magnetic powders have various shapes including, but not limited thereto, acicular, spherical, cubic, or plate-like shapes, for example.

### (Binder for Underlayer 12)

The binder for the underlayer 12 is similar to that in the magnetic layer 13 described above.

### (Back Layer 14)

The back layer 14 includes, for example, a binder and non-magnetic powders. The back layer 14 may further include at least one additive of a lubricant, a curing agent, an antistatic agent, or the like, as needed. The binder and the non-magnetic powders in the back layer 14 are similar to the binder and the non-magnetic powders in the underlayer 12 described above.

The average particle size of the non-magnetic powders in the back layer 14 is preferably 10 nm or more and 150 nm or less, and more preferably 15 nm or more and 110 nm or less. The average particle size of the non-magnetic powders in the back layer 14 is determined in the same manner as for the average particle size of the magnetic powders in the magnetic layer 13 described above. The non-magnetic powders may include one having a granularity distribution of two or more.

The upper limit value of the average thickness of the back layer 14 is preferably 0.6 μm or less, and particularly preferably 0.5 μm or less. When the upper limit value of the average thickness of the back layer 14 is 0.6 μm or less, it is possible to keep the thicknesses of the underlayer 12 and the substrate 11 thick even in a case where the average thickness of the magnetic recording tape 10 is 5.3 μm or less, and thus to maintain traveling stability of the magnetic recording tape 10 in the recording/reproducing apparatus. The lower limit value of the average thickness of the back layer 14 is, for example, but not particularly limited to, 0.2 μm or more, and particularly preferably 0.3 μm or more.

The average thickness of the back layer 14 is determined as follows. First, the magnetic recording tape 10 having a width of ½ inches is prepared, and cut into a length of 250 mm to produce a sample. Next, the measuring apparatus, Laser Hologauge (LGH-110C) manufactured by Mitsutoyo Corporation, is used to measure the thickness of the sample of the magnetic recording tape 10 at five points or more. Thereafter, these measurement values are simply averaged (arithmetically averaged) to calculate an average thickness t_{T} [μm] of the magnetic recording tape 10. It is to be noted that the measurement positions are randomly selected on the sample. Subsequently, the back layer 14 is removed from the sample of the magnetic recording tape 10 with a solvent, such as MEK (methyl ethyl ketone) or dilute hydrochloric acid. Thereafter, the Laser Hologauge is used again to measure the thickness of the sample of the magnetic recording tape 10 from which the back layer 14 has been removed, at five points or more. These measurement values are simply averaged (arithmetically averaged) to calculate an average thickness t_{B} [μm] of the magnetic recording tape 10 from which the back layer 14 has been removed. It is to be noted that the measurement positions are randomly selected on the sample. Finally, an average thickness t_{b} [μm] of the back layer 14 is determined by the following expression.

t_{b} [μm]=t_{T} [μm]−t_{B} [μm]

### (Average Thickness of Magnetic Recording Tape 10)

The upper limit value of an average thickness (average total thickness) T10 of the magnetic recording tape 10 is preferably 5.6 μm or less, and more preferably 5.3 μm or less. When the average thickness of the magnetic recording tape 10 is 5.6 μm or less, it is possible to increase the recordable recording capacity of one magnetic recording cartridge 1, as compared with a common magnetic recording medium. In addition, the lower limit value of the average thickness of the magnetic recording tape 10 is preferably 4.0 μm or more, for example. When the average thickness of the magnetic recording tape 10 is 4.0 μm or more, it is possible to effectively suppress deformation of the magnetic recording tape 10.

The average thickness T10 of the magnetic recording tape 10 is determined as follows. First, the magnetic recording tape 10 having a width of ½ inches is prepared, and cut into a length of 250 mm to produce a measurement sample. It is to be noted that the measurement samples of the same number for measuring the average thickness T10 are collected from the vicinity of the measurement sample to be collected when measuring Young' modulus in the longitudinal direction. Next, the measuring apparatus, Laser Hologauge (LGH-110C) manufactured by Mitsutoyo Corporation, is used to measure the thickness of the sample at five points or more. Thereafter, these measurement values are simply averaged (arithmetically averaged) to calculate an average value [μm]. The average value corresponds to the average thickness T10 of the magnetic recording tape 10. It is to be noted that the measurement points are randomly selected on the sample.

### (Coercivity Hc)

The upper limit value of the coercivity Hc of the magnetic recording tape 10 in the longitudinal direction is preferably 2000 Oe or less, more preferably 1900 Oe or less, and still more preferably 1800 Oe or less. When coercivity Hc2 in the longitudinal direction is 2000 Oe or less, a high-sensitivity magnetization reaction is caused by a magnetic field in the perpendicular direction from the magnetic head, thus allowing for formation of a favorable recording pattern.

The lower limit value of the coercivity Hc measured in the longitudinal direction of the magnetic recording tape 10 is preferably 1000 Oe or more. When the lower limit value of the coercivity He in the longitudinal direction is 1000 Oe or more, it is possible to suppress demagnetization due to a leakage flux from the recording head.

The above-described coercivity Hc is determined as follows. Three sheets of the magnetic recording tape 10 are overlapped on each other by bonding with double-sided tapes, and then punched out by a 6.39 mm-diameter punch to prepare measurement samples. At this time, marking is performed with any ink having no magnetism to allow the longitudinal direction (traveling direction) of the magnetic recording tape 10 to be recognizable. Then, a vibrating sample magnetometer (VSM) is used to measure M-H loop of the measuring samples (entire magnetic recording tape 10) corresponding to the longitudinal direction of the magnetic recording tape 10 (traveling direction of the magnetic recording tape 10). Next, acetone, ethanol, or the like is used to wipe off the coated film (underlayer 12, magnetic layer 13, and back layer 14, etc.) to leave only the substrate 11. Then, three sheets of the obtained substrates 11 are overlapped on each other by bonding with double-sided tapes, and then punched out by a 6.39 mm-diameter punch to obtain background-correction samples (hereinafter, simply referred to as correction samples). Thereafter, the VSM is used to measure the M-H loop of the correction samples (substrate 11) corresponding to the longitudinal direction of the substrate 11 (traveling direction of the magnetic recording tape 10). It is to be noted that, when determining the coercivity He in the longitudinal direction of the magnetic recording tape 10, the measurement samples and the correction samples described above are collected at three locations of different positions, along the longitudinal direction, of the magnetic recording medium TM to be accommodated in the magnetic recording cartridge 1. Specifically, as for the magnetic recording tape 10 of the magnetic recording medium TM, the measurement samples and the correction samples described above are collected at three locations of a position 10 m distant from the coupling part 4 coupled to the leader tape 20, a position 30 m distant from the coupling part 4, and a position 60 m distant from the coupling part 4. Arithmetic average of respective coercivities Hc determined by the M-H loop measured for the measurement samples and the correction samples acquired at each of the three locations is calculated to thereby determine the coercivity Hc of the magnetic recording tape 10 in the longitudinal direction.

For example, a high sensitivity vibrating sample magnetometer “VSM-P7-15” manufactured by Toei Industry Co., Ltd. is used to measure the M-H loop of the measurement samples (entire magnetic recording tape 10) and the M-H loop of the correction samples (substrate 11). Measurement conditions are as follows: measurement mode: full loop, maximum magnetic field: 15 kOe, magnetic field step: 40 bits, Time constant of Locking amp: 0.3 sec, Waiting time: 1 sec, and MH averaging number: 20.

After the two M-H loops are obtained, the M-H loop of the correction samples (substrate 11) is subtracted from the M-H loop of the measurement samples (entire magnetic recording tape 10) to perform background correction, and an M-H loop after the background correction is thereby obtained. Measurement and analysis programs attached to the “VSMP7-15” are used for calculation in the background correction.

The coercivity Hc is determined from the obtained M-H loop after the background correction. It is to be noted that the measurement and analysis programs attached to the “VSM-P7-15” are used for this calculation. It is to be noted that the measurements of the M-H loops described above are both performed at 25° C. In addition, “demagnetizing field correction” is not performed when the M-H loop is measured in the longitudinal direction of the magnetic recording tape 10.

### (Squareness Ratio)

A squareness ratio S1 in the vertical direction (thickness direction) of the magnetic recording tape 10 is, for example, 65% or more, preferably 67% or more, more preferably 70% or more, still more preferably 75% or more, and particularly preferably 80% or more. When the squareness ratio S1 is 65% or more, the vertical orientation of the magnetic powders becomes sufficiently high. Therefore, it is possible to obtain a much superior SNR.

The squareness ratio S1 is calculated from the same M-H loop as the M-H loop used when calculating the above-described coercivity Hc, for example. That is, the M-H loop is measured in the same manner as the above-described method for calculating the coercivity He to calculate the squareness ratio S1.

Saturation magnetization Ms (emu) and residual magnetization Mr (emu) of the M-H loop obtained after the background correction when calculating the above-described coercivity Hc are substituted in the following expression to calculate the squareness ratio S1 (%).

Squareness Ratio S1(%)=(Mr/Ms)×100

It is to be noted that the measurement of the M-H loops described above are both performed at 25° C. In addition, the “demagnetizing field correction” is not performed when the M-H loop is measured in the vertical direction of the magnetic recording tape 10.

A squareness ratio S2 in the longitudinal direction (traveling direction) of the magnetic recording tape 10 is preferably 35% or less, more preferably 30% or less, still more preferably 25% or less, particularly preferably 20% or less, and most preferably 15% or less. When the squareness ratio S2 is 35% or less, the vertical orientation of the magnetic powders becomes sufficiently high. Therefore, it is possible to obtain a much superior SNR.

The squareness ratio S2 is determined in the same manner as for the squareness ratio S1 except that the M-H loops are measured in the longitudinal direction (traveling direction) of the magnetic recording tape 10 and the substrate 11.

### (SFD)

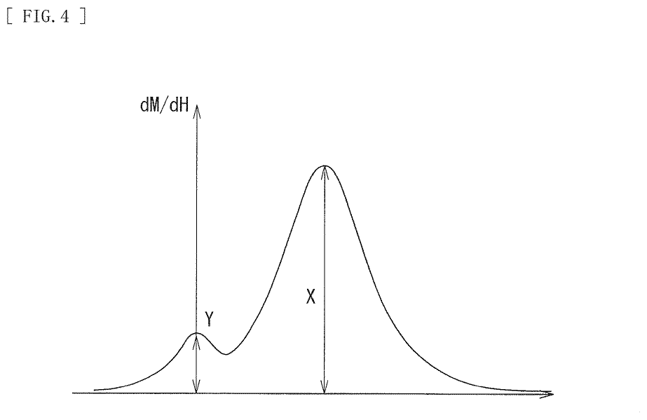

In an SFD (Switching Field Distribution) curve of the magnetic recording tape 10, the peak ratio X/Y between a main peak height X and a sub-peak height Y near zero magnetic field is preferably 3.0 or more, more preferably 5.0 or more, still more preferably 7.0 or more, particularly preferably 10.0 or more, and most preferably 20.0 or more (see FIG. 4). FIG. 4 is a graph illustrating an example of the SFD curve of the magnetic recording tape 10 illustrated in FIG. 2. When the peak ratio X/Y is 3.0 or more, it is possible to suppress a large amount of low coercivity components (e.g., soft magnetic particles or superparamagnetic particles), peculiar to ε-iron oxide, being contained in the magnetic powders, other than the ε-iron oxide particles 50 contributing to actual recording. Therefore, it is possible to suppress the deterioration of magnetization signals recorded in adjacent tracks due to leakage of a magnetic field from the recording head, and thus to obtain a much superior SNR. The upper limit value of the peak ratio X/Y is, for example, but not particularly limited to, 100 or less.

The peak ratio X/Y is determined as follows. First, the M-H loop after the background correction is obtained in the same manner as in the method of measuring the coercivity Hc described above. Next, the SFD curve is calculated from the obtained M-H loop. For the calculation of the SFD curve, a program attached to the measuring apparatus may be used, or other programs may be used. The peak ratio X/Y is calculated, where “Y” is the absolute value of the point at which the calculated SFD curve crosses a Y-axis (dM/dH), and “X” is the height of the main peak observed in the vicinity of the coercivity Hc in the M-H loop. It is to be noted that the measurement of the M-H loop is performed at 25° C. in the same manner as in the method of measuring the coercivity Hc described above. In addition, the “demagnetizing field correction” is not performed when the M-H loop is measured in the thickness direction (vertical direction) of the magnetic recording tape 10. Further, a plurality of samples to be measured may be overlapped on each other for the measurement of the M-H loop depending on the sensitivity of the VSM to be used.

### (Dimensional Change Amount Δw)

A dimensional change amount Δw [ppm/N] of the magnetic recording tape 10 in the width direction with respect to a tensional change in the magnetic recording tape 10 in the longitudinal direction is preferably represented by 650 ppm/N≤Δw, more preferably 700 ppm/N≤Δw, still more preferably 750 ppm/N≤Δw, and particularly preferably 800 ppm/N≤Δw. When the dimensional change amount Δw is represented by 650 ppm/N≤Δw, adjustment of the tension of a magnetic recording medium 10 in the longitudinal direction by the recording/reproducing apparatus 30 described later makes it possible to suppress the change in the width of the magnetic recording tape 10 more effectively. The upper limit value of the dimensional change amount Δw is not particularly limited; however, the following may hold true: for example, Δw≤1700000 ppm/N, preferably Δw≤20000 ppm/N, more preferably Δw≤8000 ppm/N, still more preferably Δw≤5000 ppm/N, Δw≤4000 ppm/N, Δw≤3000 ppm/N, or Δw≤2000 ppm/N.

The dimensional change amount Δw may be set to a desired value depending on selection of the substrate 11. For example, the dimensional change amount Δw may be set to a desired value by selecting at least one of the thickness of the substrate 11 or a material of the substrate 11. In addition, the dimensional change amount Δw may be set to a desired value, for example, by adjusting the stretching intensity in the width direction and the longitudinal direction of the substrate 11. For example, stretching more intensely in the width direction of the substrate 11 further decreases the dimensional change amount Δw; conversely, intensifying the stretching in the longitudinal direction of the substrate 11 increases the dimensional change amount Δw.

The dimensional change amount Δw is determined as follows. First, the magnetic recording medium 10 having a width of ½ inches is prepared, and cut into a length of 250 mm to acquire a sample 10S. Next, a load is applied in the order of 0.2 N, 0.6 N, and 1.0 N in the longitudinal direction of the sample 10S, and the width of the sample 10S is measured at the loads of 0.2 N, 0.6 N, and 1.0 N. Subsequently, the dimensional change amount Δw is determined by the following expression. It is to be noted that the measurement in the case of applying the load of 0.6 N is performed to confirm that there is no abnormality in the measurement (in particular, to confirm that these three measurement results are linear); the measurement result is not used in the following expression.

$$[ Mathematical Expression 1 ]$$

$$Δ w [ ppm / N ] = \frac{D ( 0.2 N ) [ mm ] - D ( 1. N ) [ mm ]}{D ( 0.2 N ) [ mm ]} \times \frac{1 , 000 , 000}{( 1. [ N ] ) - ( 0.2 [ N ] )}$$

(Note that, in the expression, D (0.2 N) and D (1.0 N) denote widths of the sample 10S at the time when the respective loads of 0.2 N and 1.0 N are applied in the longitudinal direction of the sample 10S.)

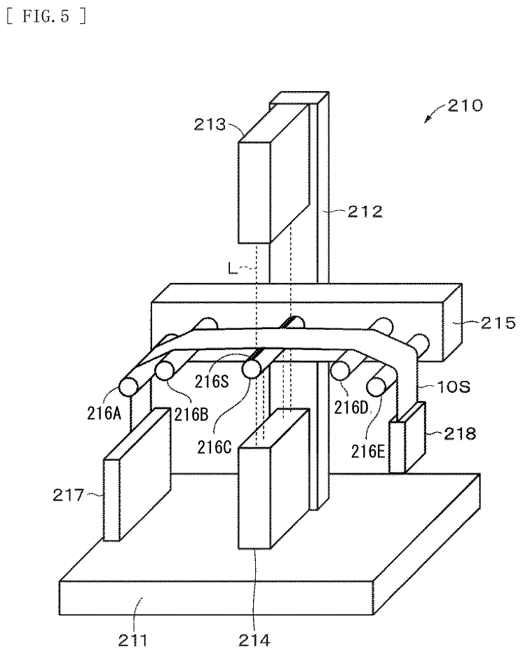

The width of the sample 10S at the time when each of the loads is applied is measured using a measuring apparatus, for example, illustrated in FIG. 5. FIG. 5 is a schematic outline view of an appearance of a measuring apparatus 210 to be used to measure the width of the magnetic recording medium 10. First, a description is given of the measuring apparatus 210 with reference to FIG. 5. The measuring apparatus 210 includes a seating 211, a support column 212, a light emitter 213, a light receiver 214, a support plate 215, five support members 216A to 216E, and a fixing part 217.

The seating 211 has a rectangular plate shape. The light receiver 214 is provided in the middle of the seating 211. The support column 212 stands adjacent to the light receiver 214 at a position offset toward one long side from the center of the seating 211. The fixing part 217 is provided on one short side of the seating 211.

The light emitter 213 is supported at the tip portion of the support column 212. The light emitter 213 and the light receiver 214 are opposed to each other. Upon measuring, the sample 10S supported by the support members 216A to 216E is disposed between the light emitter 213 and the light receiver 214 opposed to each other. The light emitter 213 and the light receiver 214 are coupled to a PC (personal computer), measure the width of the sample 10S supported by the support members 216A to 216E under the control of the PC, and output measurement results to the PC.

The light emitter 213 and the light receiver 214 incorporate a digital dimension measuring instrument LS-7000 manufactured by Keyence Corporation. The light emitter 213 irradiates the sample 10S with linear light parallel to a width direction of the sample 10S supported by the support members 216A to 216E. The light receiver 214 measures the width of the sample 10S by measuring an amount of light not having been blocked by the sample 10S.

An elongated rectangular support plate 215 is fixed to the support column 212 at a position substantially half the height thereof. The support plate 215 is supported to allow a long side of the support plate 215 to be parallel to a main surface of the seating 211. One main surface of the support plate 215 supports the five support members 216A to 216E. The support member 216A to 216E each have a cylindrical rod shape, and support a back surface of the sample 10S (magnetic recording medium 10). All of the five support members 216A to 216E (in particular, surfaces thereof) are each configured by stainless steel SUS304, and each have a surface roughness Rz (maximum height) of 0.15μ m to 0.3μ m.

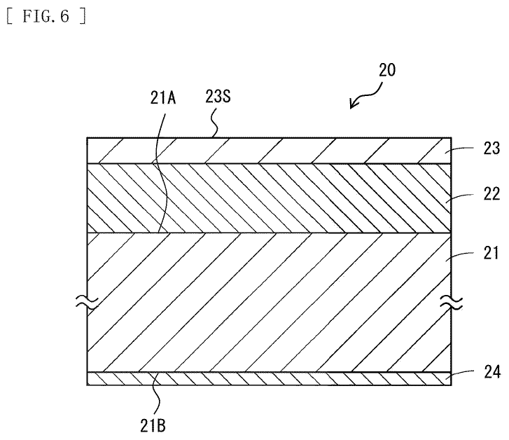

Here, a description is given of the arrangement of the five support members 216A to 216E with reference to FIG. 5. As illustrated in FIG. 6, the sample 10S is placed on the five support members 216A to 216E. Each of the five support members 216A to 216E has a diameter of 7 mm, for example. A distance d1 (in particular, a distance between center axes of these support members) between the support member 216A and the support member 216B is 20 mm. A distance d2 between the support member 216B and the support member 216C is 30 mm. A distance d3 between the support member 216C and the support member 216D is 30 mm. A distance d4 between the support member 216D and the support member 216E is 20 mm.

In addition, these three support members 216B to 216D are arranged to allow a portion of the sample 10S riding between the support member 216B, the support member 216C, and the support member 216D to form a plane substantially perpendicular to the direction of gravitational force. In addition, the support member 216A and the support member 216B are arranged to allow the sample 10S to form an angle of 01=30° relative to the above-described substantially perpendicular plane between the support member 216A and the support member 216B. Further, the support member 216D and the support member 216E are arranged to allow the sample 10S to form an angle of θ2=30° relative to the above-described substantially perpendicular plane between the support member 216D and the support member 216E. In addition, among the five support members 216A to 216E, the support member 216C is fixed not to rotate, but all of the other four support members 216A, 216B, 216D, and 216E are rotatable.

Among the support members 216A to 216E, a slit 216S is provided in the support member 216C, which is positioned between the light emitter 213 and the light receiver 214 and is positioned at substantially the center between the fixing part 217 and a portion to be loaded. Light L is irradiated from the light emitter 213 to the light receiver 214 through the slit 216S. The slit width of the slit 216S is 1 mm, and the light L is able to pass through the slit 216S without being blocked by a frame of the slit 216S.

When measuring the width of the sample 10S upon application of each load using the measuring apparatus 210, the sample 10S is first set on the measuring apparatus 210. Specifically, one end of the elongated sample 10S is fixed by the fixing part 217. Next, the sample 10S is placed on the five support members 216A to 216E. At this time, the back surface of the sample 10S is brought into contact with the five support members 216A to 216E.

Next, the measuring apparatus 210 is accommodated in a chamber controlled into a constant environment of a temperature of 25° C. and a relative humidity of 50%, and then a weight 233 for application of a load of 0.2 N is attached to the other end of the sample 10S. The sample 10S is held within the above-described environment for 2 hours or more to adapt the sample 10S to the environment. After the holding for 2 hours or more, the width of the sample 10S is measured. Specifically, the light L is irradiated from the light emitter 213 toward the light receiver 214 with a load 218 of 0.2 N being attached thereto, and the width of the sample 10S to which the load is applied in the longitudinal direction is measured. The measurement of the width is performed in a state where the sample 10S is not curled. Next, the weight for the application of a load of 0.2 N is changed to a weight for application of a load of 0.6 N to measure the width of the sample 10S five minutes after this change. Finally, the weight is changed to a weight for application of a load of 0.1 N to measure the width of the sample 10S five minutes after this change.

### (Temperature Expansion Coefficient α)

As for the temperature expansion coefficient α of the magnetic recording tape 10, it is preferable that 3 [ppm/° C.]≤α≤10 [ppm/° C.] hold true. When the temperature expansion coefficient α falls within the range mentioned above, adjustment of the tension of the magnetic recording tape 10 in the longitudinal direction by the recording/reproducing apparatus 30 described later makes it possible to suppress the change in the width of the magnetic recording tape 10.

The temperature expansion coefficient α is determined as follows. First, the sample 10S is produced in the same manner as the method of measuring the dimensional change amount Δw, and the sample 10S is set in the measuring apparatus 210 which is similar to that in the method of measuring the dimensional change amount Δw. Thereafter, for example, in a case of measuring the temperature expansion coefficient α in a relative humidity environment of 10% RH, the measuring apparatus 210 in which the sample 10S is set is accommodated in a chamber controlled into a constant environment of a temperature of 29° C. and a relative humidity of 10%. Next, a load of 0.2 N is applied in the longitudinal direction of the sample 10S, and the sample 10S is held for 2 hours or more to be adapted to the above-described environment. Thereafter, with the relative humidity of 10% being maintained, the temperature is changed in the order of 45° C., 29° C., and 10° C., the width of the sample 10S is measured at 45° C. and 10° C., and the temperature expansion coefficient α is determined by the following expression. It is to be noted that the measurement of the width of the sample 10S at a temperature of 29° C. is performed to confirm that there is no abnormality in the measurement (in particular, to confirm that these three measurement results are linear); the measurement result is not used in the following expression.

$$[ Mathematical Expression 2 ]$$

$$α [ ppm / ° C . ] = \frac{D ( 45 ° C . ) [ mm ] - D ( 10 ° C . ) [ mm ]}{D ( 10 ° C . ) [ mm ]} \times \frac{1 , 000 , 000}{( 45 [ ° C . ] ) - ( 10 [ ° C . ] )}$$

(Note that, in the expression, D (45° C.) and D (10° C.) denote respective widths of the sample 10S at temperatures of 45° C. and 10° C.)
Also in a case of measuring the temperature expansion coefficient α in relative humidity environments of 40% RH and 80% RH, the measurement is performed in the same manner as described above.

### (Humidity Expansion Coefficient β)

As for a humidity expansion coefficient β of the magnetic recording tape 10, it is preferable that β≤5 [ppm/% RH] hold true. When the humidity expansion coefficient β falls within the range mentioned above, adjustment of the tension of the magnetic recording tape 10 in the longitudinal direction by the recording/reproducing apparatus 30 makes it possible to further suppress the change in the width of the magnetic recording tape 10.

The humidity expansion coefficient β is determined as follows. First, the sample 10S is produced in the same manner as the method of measuring the dimensional change amount Δw, and the sample 10S is set in the measuring apparatus 210 which is similar to that in the method of measuring the dimensional change amount Δw. Thereafter, for example, in a case of measuring the humidity expansion coefficient β in a temperature environment of 10° C., the measuring apparatus 210 in which the sample 10S is set is accommodated in a chamber controlled into a constant environment of a temperature of 10° C. and a relative humidity of 24%. Next, a load of 0.2 N is applied in the longitudinal direction of the sample 10S, and the sample 10S is held for 2 hours or more to be adapted to the above-described environment. Thereafter, with the temperature of 10° C. being maintained, the relative humidity is changed in the order of 80%, 24%, and 10%, the width of the sample 10S is measured at 80% and 10%, and the humidity expansion coefficient β is determined by the following expression. It is to be noted that the measurement of the width of the sample 10S at a humidity of 24% is performed to confirm that there is no abnormality in the measurement (in particular, to confirm that these three measurement results are linear); the measurement result is not used in the following expression.

$$[ Mathematical Expression 3 ]$$

$$β [ ppm / \% RH ] = \frac{D ( 80 \% ) [ mm ] - D ( 10 \% ) [ mm ]}{D ( 10 \% ) [ mm ]} \times \frac{1 , 000 , 000}{( 80 [ \% ] ) - ( 10 [ \% ] )}$$

(Note that, in the expression, D) (80%) and D (10%) denote respective widths of the sample 10S at relative humidities of 80% and 10%.)
Also in a case of measuring the humidity expansion coefficient β in temperature environments of 35° C. and 60° C., the measurement is performed in the same manner as described above.

### (Leader Tape 20)

FIG. 6 schematically illustrates a cross-sectional configuration example of the leader tape 20. As illustrated in FIG. 6, the leader tape 20 has a stacked structure in which a plurality of layers are stacked, in the same manner as the magnetic recording tape 10. Specifically, the leader tape 20 includes an elongated tape-like substrate 21, an underlayer 22 provided on a main surface 21A of the substrate 21, a magnetic layer 23 provided on the underlayer 22, and a back layer 24 provided on a main surface 21B, of the substrate 21, on a side opposite to the main surface 21A. When the magnetic recording medium TM travels, a surface of a magnetic head slides on a surface 23S of the magnetic layer 23. It is to be noted that the underlayer 22 and the back layer 24 are provided as needed, or may be omitted. It is to be noted that the magnetic layer 23 of the leader tape 20 does not record data. However, the leader tape 20 including the magnetic layer 23 enables the magnetic layer 23 to record in advance an identification signal that is able to identify the leader tape 20. By doing so, for example, it is possible to prevent data from being erroneously recorded in the leader tape 20. In addition, the leader tape 20 has a structure, in which a plurality of layers, e.g., the underlayer 22 and the magnetic layer 23 are stacked on the substrate 21, thereby making it possible to have a friction coefficient more suitable for traveling than a case where the leader tape 20 only includes the substrate 21. This enables the leader tape 20 to travel more smoothly.

The configurations of the substrate 21, the underlayer 22, the magnetic layer 23, and the back layer 24 of the leader tape 20 can be substantially equal, respectively, to the configurations of the substrate 11, the underlayer 12, the magnetic layer 13, and the back layer 14 of the magnetic recording tape 10 described above. However, the configurations of the substrate 21, the underlayer 22, the magnetic layer 23, and the back layer 24 of the leader tape 20 may differ, respectively, from the configurations of the substrate 11, the underlayer 12, the magnetic layer 13, and the back layer 14 of the magnetic recording tape 10. For example, an acicular inorganic material may be used for the underlayer 12 of the magnetic recording tape 10, or an inorganic material other than the acicular inorganic material may be used for the underlayer 22 of the leader tape 20.

### (Average Thickness of Leader Tape 20)

An average thickness (average total thickness) T20 of the leader tape 20 is, for example, 5.0 μm or more and 18.0 μm or less. The average thickness T20 is thicker than the average thickness T10 of the magnetic recording tape 10. A difference between the average thickness T20 of the leader tape 20 and the average thickness T10 of the magnetic recording tape 10 is, for example, 12 μm or less. A thickness of the substrate 21 is, for example, 3.0 μm or more and 15.0 μm or less. A thickness of the underlayer 22 is 0.6 μm or more and 3.0 μm or less. A thickness of the magnetic layer 23 is 0.05 μm or more and 0.30 μm or less. A thickness of the back layer 24 is 0.2 μm or more and 1.0 μm or less.

The average thickness T20 of the leader tape 20 is determined by a method similar to that for the average thickness T10 of the magnetic recording tape 10, for example. It is to be noted that measurement samples of the same number for measuring the average thickness T20 are collected from the vicinity of the measurement sample to be collected when measuring Young' modulus in the longitudinal direction.

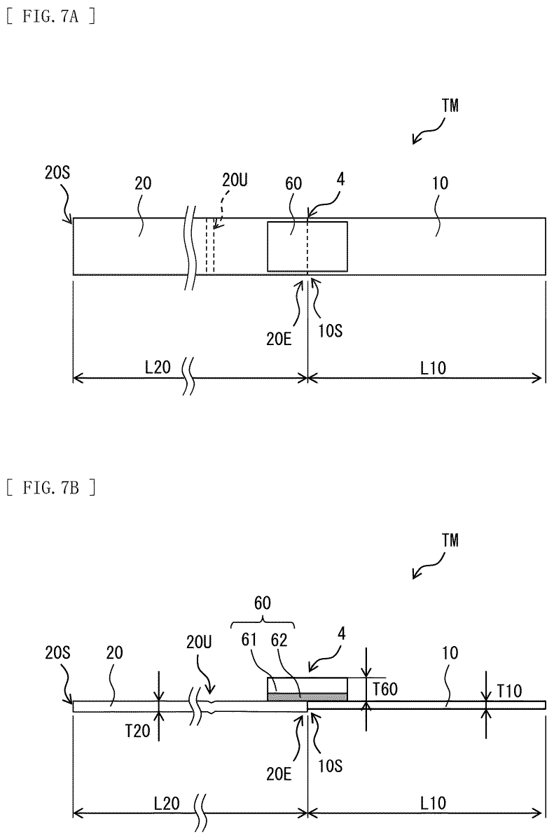

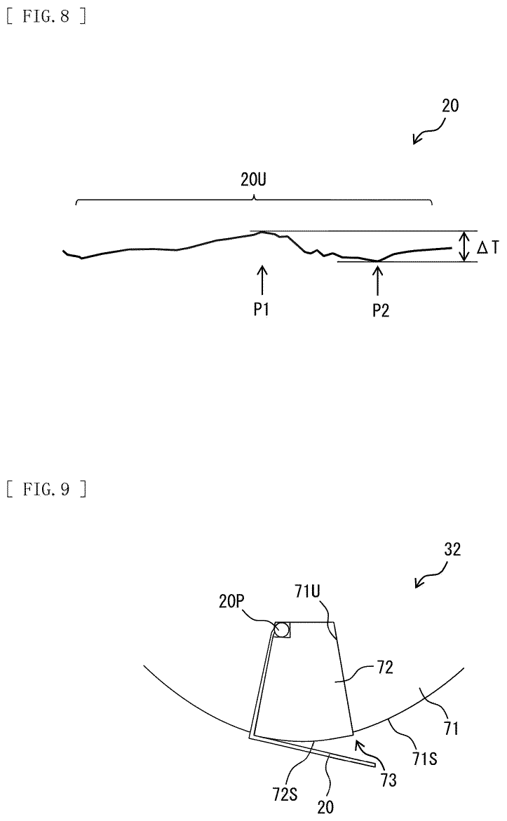

The leader tape 20 is coupled to the magnetic recording tape 10 by a splicing tape 60, for example as illustrated in FIGS. 7A and 7B. FIG. 7A is an enlarged schematic plan view of a portion of the leader tape 20 and the magnetic recording tape 10. FIG. 7B is an enlarged schematic cross-sectional view of a portion of the leader tape 20 and the magnetic recording tape 10. The splicing tape 60 is provided at the coupling part 4 (FIG. 1) between the leader tape 20 and the magnetic recording tape 10. The splicing tape 60 is adhered to each of a termination 20E of the leader tape 20 and a beginning 10S of the magnetic recording tape 10. As illustrated in FIG. 7B, the splicing tape 60 has a thickness T60. An average thickness T60 is, for example, 5 μm or more and 24 μm or less.

The splicing tape 60 includes, for example, a base material 61 and an adhesive layer 62 provided on a surface of the base material 61. The base material 61 is configured by, for example, the same constituent material as the constituent material of the substrate 11 of the magnetic recording tape 10 described above. The base material 61 is, for example, a polyester film. A thickness of the base material 61 is, for example, 16.0 μm. The adhesive layer 62 can be configured using, for example, a pressure sensitive adhesive. A thickness of the adhesive layer 62 is, for example, 6.0μ m.

Repetitive traveling of the magnetic recording medium TM under certain conditions causes a plurality of stepped parts 20U, being present intermittently in the longitudinal direction of the magnetic recording medium TM, to be generated on the leader tape 20. As used herein, the certain conditions are conditions in which reciprocating traveling is performed 140 times throughout the entire length between the cartridge reel 3 and the take-up reel 32 in an environment of a temperature of 25° C. and a relative humidity of 45% RH, for example, pursuant to the standard of LTO 9, in the recording/reproducing apparatus 30 described later. The maximum traveling speed during the traveling is 8 m/min. As a result of the traveling in such certain conditions, the stepped part 20U at a position closest to the coupling part 4 between the leader tape 20 and the magnetic recording tape 10, among the plurality of stepped parts 20U generated on the leader tape 20, has a maximum step difference ΔT of 34 μm or less in a thickness direction of the leader tape 20. It is to be noted that FIGS. 7A and 7B only illustrate only the stepped part 20U at the position closest to the coupling part 4, among the plurality of stepped parts 20U. Here, as illustrated in FIG. 8, the maximum step difference ΔT refers to a difference between a highest position P1 in the thickness direction and a lowest position P2 in the thickness direction, among irregularities on the surface of the leader tape 20, which constitute the stepped part 20U. That is, the maximum step difference ΔT refers to the maximum variation range in the thickness direction of the leader tape 20. It is to be noted that FIG. 8 is an explanatory schematic view of a shape of the irregularities on the surface of the leader tape 20 caused by the traveling under the certain conditions described above. It is to be noted that, in the traveling pursuant to the standard of LTO 9, for example, a tension of 0.4 N to 1.3 N, typically, a tension of about 0.8 N is applied to the magnetic recording medium TM.

It is to be noted that the plurality of stepped parts 20U are generated due to a step difference 73 between a core 71 and a leader block 72 in the take-up reel 32, for example, as illustrated in FIG. 9. Thus, the plurality of stepped parts 20U are present, in the longitudinal direction, at an interval corresponding to an integral multiple of an outer diameter of the core 71 (described later) of the take-up reel 32. FIG. 9 is an enlarged schematic view of a portion of the take-up reel 32. The core 71 is a member around which the magnetic recording medium TM is wound. The core 71 is provided with a recess 71U into which the leader block 72 is fitted. The leader block 72 is provided fittably into the recess 71U. The leader block 72 fitted into the recess 71U sandwiches the leader pin 20P of the leader tape 20 with the core 71. When the leader block 72 is fitted into the recess 71U, a surface 72S of a portion of the leader block 72 and an outer surface 71S of the core 71 form an outer circumferential surface of one substantial cylinder. However, the step difference 73 is generated between the surface 72S of a portion of the leader block 72 and the outer surface 71S of the core 71. When the magnetic recording medium TM is wound around the take-up reel 32, such a step difference 73 may be transferred onto the leader tape 20 and thus also transferred onto the magnetic recording tape 10, in some cases. Such a transfer onto the magnetic recording tape 10 is likely to prevent an appropriate distance from being maintained with respect to a recording/reproducing head in the course of recording or reproducing information, which may cause recording failure or loss of information. Therefore, in the present disclosure, the average thickness T20 of the leader tape 20, a length of the leader tape 20, and a layer structure of the leader tape 20 are appropriately adjusted to thereby allow the maximum step difference ΔT of the stepped part 20U present closest to the coupling part 4 to be 34 μm or less. It is to be noted that the maximum step difference ΔT is a parameter determined noy only by the average thickness T20 of the leader tape 20 and the length of the leader tape 20, but determined by adjusting materials and thicknesses of the layers such as the substrate 21, the underlayer 22, the magnetic layer 23, and the back layer 24 that constitute the leader tape 20. By allowing the maximum step difference ΔT of the stepped part 20U present closest to the coupling part 4 to be 34 μm or less, among the plurality of stepped parts 20U generated on the leader tape 20, favorable recording operations and reproduction operations are ensured, thus improving operational reliability.

### [1-3. Method of Measuring Maximum Step Difference at of Leader Tape 20]

### (Measuring Apparatus and Measuring Conditions Thereof)

Next, a description is given of a method of measuring the maximum step difference ΔT which may be generated on the leader tape 20. The leader tape 20 is collected from the magnetic recording medium TM having undergone reciprocating traveling 140 times between the cartridge reel 3 and the take-up reel 32 pursuant to the standard of LTO 9 in the recording/reproducing apparatus 30, as described above. For measuring the maximum step difference ΔT, a digital microscope manufactured by Keyence Corporation can be used as the measuring apparatus. The digital microscope includes a main body, a head, and a lens. The model names thereof and measurement conditions are exemplified below.

Main body: VHX-7000

### Head: VHX-7100

Lens: VHX-E20 (magnification: 20 to 100 times)
Lens magnification: 100 times
Shooting mode: Normal
Storage pixel size: 1200×9000 pixels
Shooting pitch: 4.00 μm

### (Preparation for Measurement)

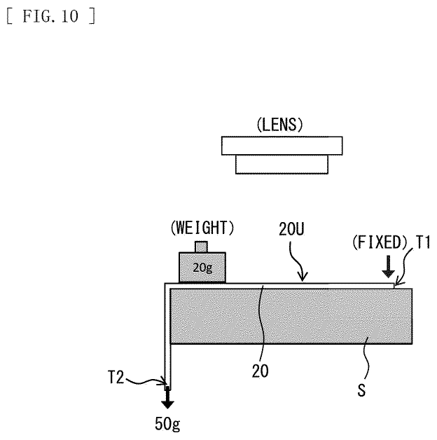

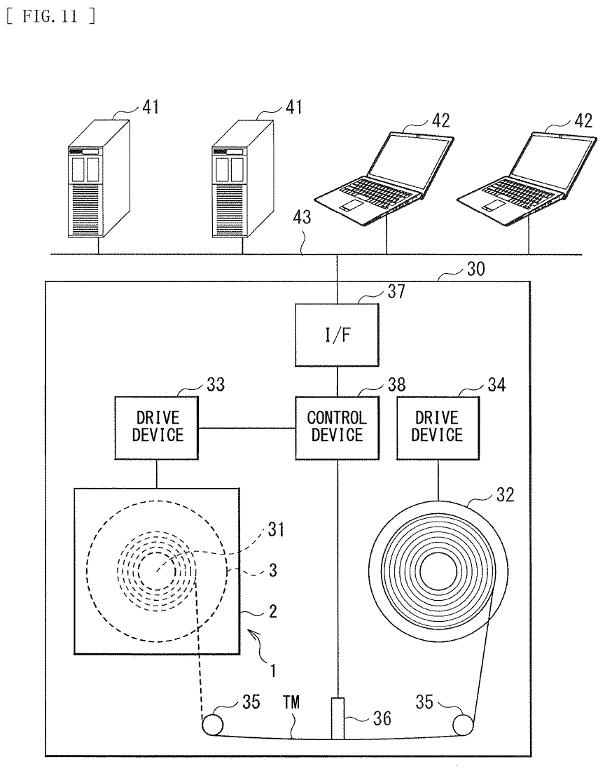

A sample of the leader tape 20 is set on a stage S of the measuring apparatus to allow the stepped part 20U of the leader tape 20, as a measurement target, to be included in an angle of view of the lens. At that time, as illustrated in FIG. 10, the sample of the leader tape 20 is set such that a first end T1 in the longitudinal direction is fixed on the stage and then a second end T2 on a side opposite to the first end T1 is drawn by a load of 50 g. Thereafter, a weight W of 20 g is placed on the sample of the leader tape 20 on the stage S not to allow the sample of the leader tape 20 to lift off from a surface of the stage S.

### (Measuring Procedure)

After the sample of the leader tape 20 is set on the stage S, the object is imaged on a monitor of the measuring apparatus, and the brightness and focus of the lens are adjusted. Next, the lens magnification is set to 100 times. Thereafter, “Depth Up” and “Quick Composition & 3D” in the menu are sequentially selected. Next, movement ranges of the upper and lower limits in a Z direction are determined. The Z direction is a thickness direction of the magnetic recording medium TM. Specifically, the lower limit value of the focus is determined while observing the stepped part 20U as an observation target. Thereafter, the upper limit value of the focus is determined while observing the stepped part 20U. Next, the shooting pitch in the Z direction is set to 4.00 μm, and is inputted to the measuring apparatus. Finally, “Execute Composition” is selected from the menu. This allows for creation of a 3D composed image in the vicinity of the stepped part 20U.

### (Reading of Result)

After the creation of the 3D composed images in the vicinity of the stepped part 20U, “3D Display” and “profile” are sequentially selected on a monitor screen. Next, “Profile Line” and “Between Two Points” are sequentially selected on the monitor screen to measure undulation of the stepped part 20U of the sample of the leader tape 20. At that time, the “profile line” is set to pass through the stepped part 20U. Thereafter, “Measurement Tool” and the “Maximum and Minimum” are sequentially selected. Further, a value displayed on the monitor screen is read as the maximum step difference ΔT.

This enables measurement of the maximum step difference ΔT of the leader tape 20.

### [1-4. Method of Manufacturing Magnetic Recording Medium TM]

Next, a description is given of a method of manufacturing the magnetic recording tape 10 having the above-described configuration. First, a coating material for forming an underlayer is prepared by kneading and dispersing non-magnetic powders, a binder, a lubricant, and the like in a solvent. Next, a coating material for forming a magnetic layer is prepared by kneading and dispersing magnetic powders, a binder, a lubricant, and the like in a solvent. Next, a coating material for forming a back layer is prepared by kneading and dispersing a binder, non-magnetic powders, and the like in a solvent. To prepare the coating material for forming a magnetic layer, the coating material for forming an underlayer, and the coating material for forming a back layer, the following solvents, dispersion apparatus, and kneading apparatus may be used, for example.

Examples of the solvent used for preparing the above-mentioned coating materials include: a ketone-based solvent, such as acetone, methyl ethyl ketone, methyl isobutyl ketone, or cyclohexanone; an alcohol-based solvent, such as methanol, ethanol, or propanol; an ester-based solvent, such as methyl acetate, ethyl acetate, butyl acetate, propyl acetate, ethyl lactate, or ethylene glycol acetate; an ether-based solvent, such as diethylene glycol dimethyl ether, 2-ethoxyethanol, tetrahydrofuran, or dioxane; an aromatic hydrocarbon solvent, such as benzene, toluene, or xylene; and a halogenated hydrocarbon solvent, such as methylene chloride, ethylene chloride, carbon tetrachloride, chloroform, or chlorobenzene. These may be used alone, and may be used in combination as appropriate.

Examples of the kneading apparatus used for the preparation of the above-mentioned coating materials may include, but not particularly limited to, a continuous twin-screw kneader, a continuous twin-screw kneader allowing for dilution in multiple stages, a kneader, a pressure kneader, a roll kneader, and other kneading apparatuses. In addition, examples of the dispersing apparatus used for the preparation of the above-mentioned coating materials may include, but not particularly limited to, a roll mill, a ball mill, a transverse sand mill, a longitudinal sand mill, a spike mill, a pin mil, a tower mil, a pearl mill (e.g., “DCP mill” manufactured by Eirich Co., Ltd., etc.), a homogenizer, an ultrasonic disperser, and other dispersing apparatuses.

Next, the coating material for forming an underlayer is applied to one main surface 11A of the substrate 11 and dried to thereby form the underlayer 12. Subsequently, the coating material for forming a magnetic layer is applied onto the underlayer 12 and dried to thereby form the magnetic layer 13 on the underlayer 12. It is to be noted that, during the drying, it is preferable to cause the magnetic field of the magnetic powders to be oriented in the thickness direction of the substrate 11 by a solenoidal coil, for example. Alternatively, during the drying, the magnetic field of the magnetic powders may be oriented in the traveling direction (longitudinal direction) of the substrate 11, and thereafter oriented in the thickness direction of the substrate 11 by a solenoidal coil, for example. Such magnetic field orientation processing makes it possible to improve the degree of vertical orientation (i.e., squareness ratio S1) of the magnetic powders. After the magnetic layer 13 is formed, the coating material for forming a back layer is applied to the other main surface 11B of the substrate 11 and dried to thereby form the back layer 14. This allows the magnetic recording tape 10 to be obtained.

The squareness ratios S1 and S2 are set to desired values by, for example, adjusting the intensity of the magnetic field applied to the coated film of the coating material for forming a magnetic layer, the concentration of a solid content in the coating material for forming a magnetic layer, and drying conditions (drying temperatures and drying times) for the coated film of the coating material for forming a magnetic layer. The intensity of the magnetic field applied to the coated film is preferably twice the coercivity of the magnetic powders. In order to further increase the squareness ratio S1 (i.e., in order to further lower the squareness ratio S2), it is preferable to improve the dispersing state of the magnetic powders in the coating material for forming a magnetic layer. In addition, in order to further increase the squareness ratio S1, it is also effective to magnetize the magnetic powders at a stage prior to the application of the coating material for forming a magnetic layer to an alignment apparatus for causing the magnetic field of the magnetic powders to be oriented. It is to be noted that the above-mentioned methods of adjusting the squareness ratios S1 and S2 may be used alone, or two or more of them may be used in combination.

Thereafter, the obtained magnetic recording tape 10 is subjected to calendering processing to planarize the surface 13S of the magnetic layer 13. Next, the magnetic recording tape 10 subjected to the calendering processing is wound into a roll shape.

Finally, the magnetic recording tape 10 is cut to have a predetermined width (e.g., ½ inch wide). This allows the magnetic recording tape 10 to be obtained as desired.

The leader tape 20 may also be manufactured in the same manner as the method of manufacturing the magnetic recording tape 10 described above.

The magnetic recording tape 10 and the leader tape 20 obtained as described above are coupled to each other to complete the magnetic recording medium TM.

### [1-5. Recording/Reproducing Apparatus 30]

### (Configuration Recording/Reproducing Apparatus 30)

Next, a description is given, with reference to FIG. 11, of the configuration of the recording/reproducing apparatus 30 for recording information on the above-described magnetic recording medium TM and reproducing information from the above-described magnetic recording medium TM. The recording/reproducing apparatus 30 is a drive compliant with the standard of LTO 9.

The recording/reproducing apparatus 30 has a configuration in which a tension applied in the longitudinal direction of the magnetic recording medium TM is adjustable. In addition, the recording/reproducing apparatus 30 has a configuration in which the magnetic recording cartridge 1 is loadable. Here, for ease of explanation, a description is given of a case where the recording/reproducing apparatus 30 has a configuration in which one magnetic recording cartridge 1 is loadable. However, in the present disclosure, the recording/reproducing apparatus 30 may have a configuration in which a plurality of magnetic recording cartridges 1 is loadable. As described above, the magnetic recording medium TM has a tape-like shape. The magnetic recording medium TM may be accommodated in a housing in a state of being wound around the cartridge reel 3 inside the magnetic recording cartridge 1, for example. The magnetic recording medium TM is configured to travel in the longitudinal direction during recording and reproduction. In addition, the magnetic recording medium TM may be configured to be able to record signals at a shortest recording wavelength of preferably 100 nm or less, more preferably 75 nm or less, still more preferably 60 nm or less, and particularly preferably 50 nm or less. The magnetic recording medium TM may be used in the recording/reproducing apparatus 30 having, for example, a shortest recording wavelength within the above ranges. The recording track width may be, for example, 2 μm or less.

The recording/reproducing apparatus 30 is coupled to information processing apparatuses, such as servers 41 and personal computers 42 (hereinafter referred to as “PCs”), via a network 43, for example. The recording/reproducing apparatus 30 is configured to be able to record data supplied from these information processing apparatuses in a magnetic recording medium cartridge 1.

As illustrated in FIG. 11, the recording/reproducing apparatus 30 includes, for example, a spindle 31, the take-up reel 32, a drive device 33, a drive device 34, a plurality of guide rollers 35, a head unit 36, a communication interface (hereinafter, referred to as I/F) 37, and a control device 38.

The spindle 31 is configured such that, for example, the magnetic recording cartridge 1 is mountable thereon. The magnetic recording cartridge 1 is compliant with the LTO (Linear Tape Open) standard, and has the cartridge case 2 rotatably accommodating a single cartridge reel 3 around which the magnetic recording medium TM is wound. An inverted V-shaped servo pattern is preliminarily recorded, as a servo signal, in the magnetic recording medium TM. The take-up reel 32 is configured to be able to fix a leading end of the magnetic recording medium TM drawn out from the magnetic recording cartridge 1, i.e., the leader pin 20P of the leader tape 20.

The drive device 33 is a device for rotationally driving the spindle 31. The drive device 34 is a device for rotationally driving the take-up reel 32. When data is recorded on or reproduced from the magnetic recording medium TM, the drive device 33 and the drive device 34 respectively rotate the spindle 31 and the take-up reel 32 to thereby cause the magnetic recording medium TM to travel. The guide rollers 35 are rollers for guiding the travel of the magnetic recording medium TM.

The head unit 36 includes a plurality of recording heads for recording data signals on the magnetic recording medium TM, a plurality of reproducing heads for reproducing data signals recorded on the magnetic recording medium TM, and a plurality of servo heads for reproducing servo signals recorded on the magnetic recording medium TM. For example, a ring-type head may be used as the recording head, and a magneto-resistive effect-type magnetic head may be used as the reproducing head, for example. However, the types of the recording head and the reproducing head are not limited thereto.

The I/F 37 is directed to communicating with the information processing apparatuses such as the servers 41 and the PCs 42, and is coupled to the network 43.

The control device 38 controls the entire recording/reproducing apparatus 30. For example, the control device 38 records data signals supplied from the information processing apparatuses on the magnetic recording medium TM using the head unit 36 in response to requests from the information processing apparatuses such as the servers 41 and the PCs 42. In addition, the control device 38 reproduces the data signals recorded on the magnetic recording medium 10 using the head unit 36 in response to requests from the information processing apparatuses such as the servers 41 and the PCs 42, and supplies the reproduced data signals to the information processing apparatuses.

### (Operation of Recording/Reproducing Apparatus)

Next, a description is given of operations of the recording/reproducing apparatus 30 having the above configuration.

First, the magnetic recording cartridge 1 is mounted on the recording/reproducing apparatus 30. The leading end of the leader tape 20 of the magnetic recording medium TM is drawn out, and transferred to the take-up reel 32 via the plurality of guide rollers 35 and the head unit 36, to attach the leader pin 20P of the leading end of the leader tape 20 to the take-up reel 32.

Next, when an unillustrated operation unit is operated, the spindle drive device 33 and the reel drive device 34 are driven under the control of the control device 38, thereby rotating the spindle 31 and the take-up reel 32 in the same direction to allow the magnetic recording medium 10 to travel from the cartridge reel 3 toward the take-up reel 32. This allows the head unit 36 to record information on the magnetic recording medium TM or reproduce information recorded on the magnetic recording medium TM while allowing the magnetic recording medium TM to be wound around the reel 32.

In addition, in a case of rewinding the magnetic recording medium TM around the cartridge reel 3, the spindle 31 and the take-up reel 32 are rotationally driven in a direction opposite to the above-described direction, thereby allowing the magnetic recording medium TM to travel from the take-up reel 32 to the cartridge reel 3. Also in this rewinding, the head unit 36 records information on the magnetic recording medium TM or reproduces information recorded on the magnetic recording medium TM.

### [1-6. Effect]

As described above, in the present embodiment, the magnetic recording medium TM includes the magnetic recording tape 10 extending in the longitudinal direction, and the leader tape 20 coupled to the magnetic recording tape 10 in the longitudinal direction. Here, the leader tape 20 is adjusted to allow the maximum step difference ΔT of the stepped part 20U at a position closest to the coupling part 4, among the plurality of stepped parts 20U generated by repetitive traveling of the magnetic recording medium TM under certain conditions, to be 34 μm or less. It is therefore possible to prevent bending, depression, or the like from being transferred onto the surface of the magnetic recording medium TM, for example, even in a case where the magnetic recording medium TM is in a state of being wound around the take-up reel 32 for storing, i.e., even in a case where the magnetic recording medium TM is pressed down. Alternatively, it is possible to reduce bending, depression, or the like transferred onto the surface of the magnetic recording medium TM. It is therefore possible to favorably perform the above without hindering the information recording operation on the magnetic recording tape 10 or the information reading operation from the magnetic recording tape 10.

### [1-7. Modification Examples]

### (Modification Example 1)

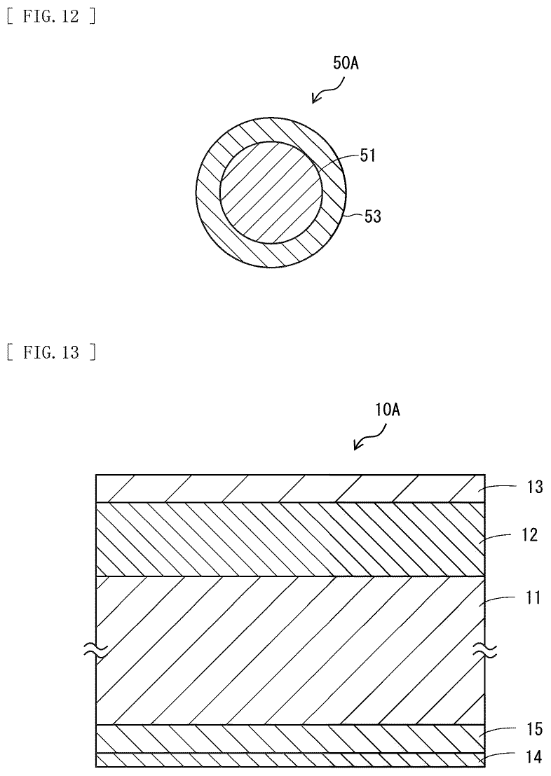

In the foregoing first embodiment, the ε-iron oxide particle 50 including the shell part 52 of a two-layer structure (FIG. 3) has been exemplified and described. However, the magnetic recording medium of the present technology may include an ε-iron oxide particle 50A including a shell part 53 of a single layer structure, as illustrated in FIG. 12, for example. The shell part 53 of the α-iron oxide particle 20A has, for example, a configuration similar to that of the first shell part 52a. However, from the viewpoint of suppressing the characteristic deterioration, the ε-iron oxide particle 50 having the shell part 52 of the two-layer structure described in the foregoing first embodiment is more preferable than the ε-iron oxide particle 50A of Modification Example 1.

### (Modification Example 2)

In the magnetic recording medium TM of the foregoing embodiment, the ε-iron oxide particle 50 having a core-shell structure has been exemplified and described. However, the ε-iron oxide particle may contain an additive instead of the core-shell structure, or may have the core-shell structure and an additive. In this case, a portion of Fe of the ε-iron oxide particle is substituted with an additive. With the ε-iron oxide particle including an additive, it is also possible to adjust the coercivity He of the entire ε-iron oxide particle to a coercivity Hc suitable for recording, and thus to improve the ease of recording. The additive includes a metal element other than iron, preferably a trivalent metal element, and more preferably at least one of Al (aluminum), Ga (gallium) In (indium), Co (cobalt), Mn (manganese), Zr (zirconium), Hf (hafnium), Cs (cesium) and Ti (titanium), Sm (samarium), Nd (neodymium), Pr (praseodymium), or Tb (terbium).

Specifically, the ε-iron oxide including an additive is an ε—Fe₂-xMxO₃ crystal (where M is a metal element other than iron, preferably a trivalent metal element, more preferably at least one of Al, Ga or In, and still more preferably at least one of Al or Ga, and x satisfies, for example, 0<x<1).

### (Modification Example 3)

The magnetic powders of the present disclosure may include nanoparticle powders that contain hexagonal ferrite (hereinafter referred to as “hexagonal ferrite particle”) instead of the ε-iron oxide particle powders. The hexagonal ferrite particle has a hexagonal plate-like or substantially hexagonal plate-like shape, for example. The hexagonal ferrite includes preferably at least one of Ba (barium), Sr (strontium). Pb (lead) or Ca (calcium), and more preferably at least one of Ba or Sr. Specifically, the hexagonal ferrite may be barium ferrite or strontium ferrite, for example. The barium ferrite may further include at least one of Sr, Pb, or Ca, in addition to Ba. The strontium ferrite may further include at least one of Ba, Pb or Ca, in addition to Sr.

More specifically, the hexagonal ferrite has an average composition represented by the general formula MFe₁₂O₁₉, where M is, for example, at least one metal of Ba, Sr, Pb or Ca, and preferably at least one metal of Ba or Sr. M may be a combination of Ba and one or more metals selected from the group consisting of Sr, Pb, and Ca. Alternatively, M may be a combination of Sr and one or more metals selected from the group consisting of Ba, Pb, and Ca. In the above general formula, a portion of Fe may be substituted with another metal element.

In a case where the magnetic powders include hexagonal ferrite particle powders, the average particle size of the magnetic powders is preferably 50 nm or less, more preferably 40 nm or less, and still more preferably 30 nm or less. More preferably, the average particle size of the magnetic powders is 25 nm or less, 22 nm or less, 21 nm or less, or 20 nm or less. In addition, the average particle size of the magnetic powders is, for example, 10 nm or more, preferably 12 nm or more, and still more preferably 15 nm or more. Therefore, the average particle size of the magnetic powders including hexagonal ferrite particle powders may be, for example, 10 nm or more and 50 nm or less, 10 nm or more and 40 nm or less, 12 nm or more and 30 nm or less, 12 nm or more and 25 nm or less, or 15 nm or more and 22 nm or less. In a case where the average particle size of the magnetic powders is equal to or less than the above-described upper limit value (e.g., 50 nm or less, particularly 30 nm or less), it is possible to obtain favorable electromagnetic conversion characteristics (e.g., SNR) of the magnetic recording medium TM having a high recording density. In a case where the average particle size of the magnetic powders is equal to or more than the above-described lower limit value (e.g., 10 nm or more, preferably 12 nm or more), it is possible to further improve the dispersibility of the magnetic powders and to obtain much superior electromagnetic conversion characteristics (e.g., SNR).

In a case where the magnetic powders include hexagonal ferrite particle powders, the average aspect ratio of the magnetic powders may be preferably 1 or more and 3.5 or less, more preferably 1 or more and 3.1 or less or 2 or more and 3.1 or less, and still more preferably 2 or more and 3 or less. When the average aspect ratio of the magnetic powders is within the above-described numerical ranges, it is possible to suppress aggregation of the magnetic powders. Further, when the magnetic powders are oriented perpendicularly in the step of forming the magnetic layer 13, it is possible to suppress the resistance applied to the magnetic powders. This may improve the vertical orientation of the magnetic powders.

It is to be noted that the average particle size and the average aspect ratio of the magnetic powders including hexagonal ferrite particle powders are determined as follows. First, a magnetic recording portion 10 to be measured is processed by the FIB (Focused Ion Beam) method or the like into a thin piece. The thinning is performed along the length direction (longitudinal direction) of the magnetic recording portion 10. The cross-section of the obtained thin sample piece is observed using a transmission electron microscope (H-9500 manufactured by Hitachi High-Technologies) at an acceleration voltage of 200 kV and total magnification of 500,000 times, in such a manner that the recording layer is entirely included in the thickness direction of the recording layer. Next, 50 particles having a side face oriented toward the surface to be observed are selected from a TEM photograph captured, and a plate thickness DA of each of the particles is measured. The plate thicknesses DA obtained in such a manner are simply averaged (arithmetically averaged) to determine an average plate thickness DAave. Subsequently, a plate diameter DB of each of the magnetic powders is measured. Here, the plate diameter DB means the distance between two parallel lines drawn so as to be in contact with the contour of the magnetic powder. Subsequently, the measured plate diameters DB are simply averaged (arithmetically averaged) to determine an average plate diameter DBave. Then, an average aspect ratio (DBave/DAave) of the particles is determined from the average plate thickness DAave and the average plate diameter DBave.

In a case where the magnetic powders include hexagonal ferrite particle powders, the average particle volume of the magnetic powders is preferably 400 nm³ or more and 1800 nm³ or less. When the average particle volume of the magnetic powders is 1800 nm³ or less, it is possible to obtain favorable electromagnetic conversion characteristics (e.g., SNR) required as the magnetic recording portion 10 having a high recording density. In particular, when the average particle volume of the magnetic powders including the hexagonal ferrite particle is 1500 nm³ or less, more favorable electromagnetic conversion characteristics are obtained. When the average particle volume of the magnetic powders is 1200 nm³ or less, still more favorable electromagnetic conversion characteristics are obtained. When the average particle volume of the magnetic powders is 400 nm³ or more, for example, thermal stability in the magnetic layer 13 is sufficiently ensured, and the recording state in the magnetic layer 13 is favorably maintained.

It is to be noted that the average particle volume of the magnetic powders is determined as follows. First, the average plate thickness DAave and the average plate diameter DBave are determined by the method of calculating the average particle size of the magnetic powders described above. Next, the average particle volume V of the magnetic powders is determined by the following expression.

$$V = \frac{3 \sqrt{3}}{8} \times {DA}_{ave} \times {DB}_{ave} \times {DB}_{ave} \qquad [ Mathematical Expression 4 ]$$

According to a particularly preferred embodiment of the present technology, the magnetic powders may be barium ferrite magnetic powders or strontium ferrite magnetic powders, and more preferably barium ferrite magnetic powders. The barium ferrite magnetic powders include magnetic particles of iron oxide having barium ferrite as a main phase (hereinafter referred to as “barium ferrite particles”). The barium ferrite magnetic powders have high reliability of the data recording; for example, the coercivity does not decrease even in a high temperature and high humidity environment. From this viewpoint, the barium ferrite magnetic powders are preferable as the magnetic powders.

In a case where the magnetic layer 13 includes the barium ferrite magnetic powders as the magnetic powders, an average thickness tm [nm] of the magnetic layer 13 is preferably 35 nm≤tm≤100 nm, and particularly preferably 80 nm or less. In addition, the coercivity Hc measured in the thickness direction (vertical direction) of the magnetic recording portion 10 is preferably 160 kA/m or more and 280 kA/m or less, more preferably 165 kA/m or more and 275 kA/m or less, and still more preferably 170 kA/m or more and 270 kA/m or less.

### (Modification Example 4)

The magnetic powders may include powders of nanoparticles containing Co-containing spinel ferrite (hereinafter referred to as “cobalt ferrite particles”), instead of the ε-iron oxide particle powders. The cobalt ferrite particles preferably have uniaxial anisotropy. The cobalt ferrite particles, for example, have a cubic or substantially cubic shape. The Co-containing spinel ferrite may further include at least one of Ni, Mn, Al, Cu or Zn, in addition to Co.

The Co-containing spinel ferrite has, for example, an average composition represented by the following formula:

CoₓM_{y}Fe₂O_{z}

(where, in the formula (1), M is, for example, a metal of at least one of Ni, Mn, Al, Cu or Zn, x is a value within the range of 0.4≤x≤1.0, and y is a value within the range of 0≤y≤0.3. Note that x and y satisfy the relationship (x+y)≤1.0, z is a value within the range of 3≤z<4, and Fe may be partially substituted with another metal element).

In a case where the magnetic powders include cobalt ferrite particle powders, the average particle size of the magnetic powders is preferably 25 nm or less, and more preferably 10 nm or more and 23 nm or less. When the average particle size of the magnetic powders is 25 nm or less, it is possible to obtain favorable electromagnetic conversion characteristics (e.g., SNR) of the magnetic recording tape 10 having a high recording density. Meanwhile, when the average particle size of the magnetic powders is 10 nm or more, it is possible to further improve the dispersibility of the magnetic powders and to obtain much superior electromagnetic conversion characteristics (e.g., SNR). In a case where the magnetic powders include the cobalt ferrite particle powders, the average aspect ratio of the magnetic powders is similar to that of the foregoing embodiment. In addition, the average particle size and the average aspect ratio of the magnetic powders are also determined in the same manner as the calculation method of the foregoing embodiment.

The average particle volume of the magnetic powders is preferably 15000 nm³ or less, and more preferably 1000 nm³ or more and 12000 nm³ or less. When the average particle volume of the magnetic powders is 15000 nm³ or less, it is possible to obtain effects similar to those in the case where the average particle size of the magnetic powders is 25 nm or less. Meanwhile, when the average particle volume of the magnetic powders is 1000 nm³ or more, it is possible to obtain effects similar to those in the case where the average particle size of the magnetic powders is 10 nm or more. It is to be noted that the average particle volume of the magnetic powders is determined in the same manner as the method of calculating the average particle volume of the magnetic powders in the foregoing first embodiment (the method of calculating the average particle volume in the case where the ε-iron oxide particle has a cubic or substantially cubic shape).

The coercivity Hc of the cobalt ferrite magnetic powders is preferably 2500 Oe or more, and more preferably 2600 Oe or more and 3500 Oe or less.

### (Modification Example 5)

As in a magnetic recording tape 10A illustrated in FIG. 13, for example, the magnetic recording tape of the present embodiment may further include a barrier layer 15 provided on at least one surface of the substrate 11. The barrier layer 15 is a layer for suppressing a dimensional change in the substrate 11 depending on an environment. For example, one example cause of the dimensional change is a hygroscopic property of the substrate 11. It is possible to reduce the rate of water penetration into the substrate 11 by providing the barrier layer 15. The barrier layer 15 includes, for example, a metal or a metal oxide. Here, the available metal may be, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta. The available metal oxide may be, for example, a metal oxide containing one or more of the above metals. More specifically, for example, at least one of Al₂O₃, CuO, CoO, SiO₂, Cr₂O₃, TiO₂, Ta₂O₅, or ZrO₂ may be used. In addition, the barrier layer 15 may include diamond-like carbon (DLC), diamond, or the like.

The average thickness of the barrier layer 15 is preferably 20 nm or more and 1000 nm or less, and more preferably 50 nm or more and 1000 nm or less. The average thickness of the barrier layer 15 is determined in the same manner as for the average thickness of the magnetic layer 13. Note that the magnification of the TEM image is appropriately adjusted depending on the thickness of the barrier layer 15.

### (Modification Example 6)

The magnetic recording medium TM according to the foregoing embodiment may be used in a library apparatus. In this case, the library apparatus may include a plurality of recording/reproducing apparatuses 30 of the foregoing embodiment.

### 2. SECOND EMBODIMENT (AN EXAMPLE OF A MAGNETIC RECORDING CARTRIDGE INCLUDING A SPUTTERED MAGNETIC RECORDING MEDIUM)

### [2-1. Configuration of Magnetic Recording Cartridge 1]

The magnetic recording cartridge 1 of the present embodiment is the same as the magnetic recording cartridge 1 described in the foregoing first embodiment except that a sputtered magnetic recording tape 10B is included, instead of the coated magnetic recording tape 10.

### [2-2. Configuration of Magnetic Recording Tape 10B]

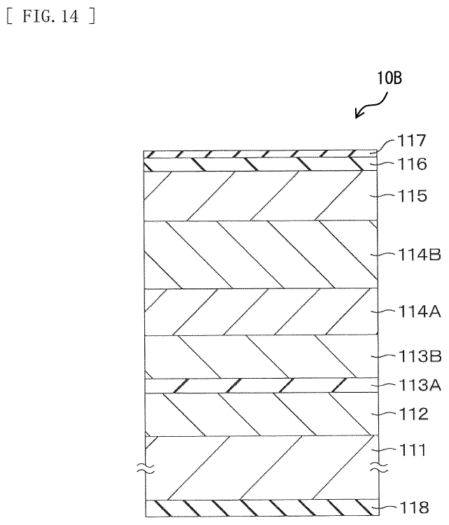

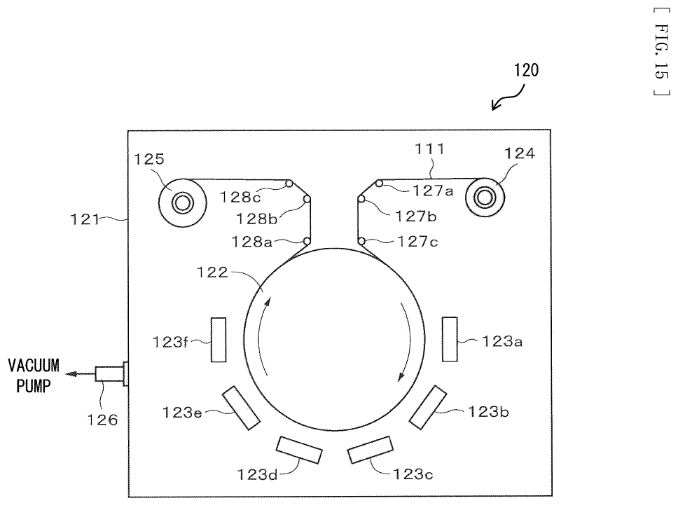

FIG. 14 schematically illustrates a cross-sectional configuration example of the magnetic recording tape 10B. A magnetic recording medium 110 is an elongated perpendicular magnetic recording medium, and has a stacked structure in which a plurality of layers are stacked as illustrated in FIG. 14. Specifically, the magnetic recording tape 10B includes, in order, an elongated tape-like substrate 111, a first seed layer 113A, a second seed layer 113B, a first underlayer 114A, a second underlayer 114B, and a magnetic layer 115. Here, an SUL 112, the first seed layer 113A, the second seed layer 113B, the first underlayer 114A, the second underlayer 114B, and the magnetic layer 115 may be, for example, a sputtered film formed by a sputtering method.

The magnetic recording tape 10B may further include, on the magnetic layer 115, a protective layer 116 and a lubricating layer 117, in order. In addition, the magnetic recording tape 10B may further include a back layer 118 provided on a second main surface of the substrate 111. In addition, a soft magnetic underlayer (Soft magnetic underlayer; SUL) 112 may be further provided on a first main surface of the substrate 111.

Hereinafter, the longitudinal direction of the magnetic recording tape 10B (longitudinal direction of the substrate 111) is referred to as a machine direction (MD: Machine Direction). Here, the machine direction means a relative movement direction of the recording and reproducing heads with respect to the magnetic recording tape 10B, i.e., a direction in which the magnetic recording tape 10B travels upon recording/reproducing.

The magnetic recording tape 10B is suitable for use as a storage medium for data archive, which is expected to be demanded increasingly in the future. The magnetic recording tape 10B is able to achieve, for example, a surface recording density that is ten times or more as high as that of a current coated magnetic recording medium for storage, i.e., a surface recording density of 50 Gb/inch² or more. In a case where a common linear-recording data cartridge is configured with the use of the magnetic recording tape 10B which has such a high surface recording density, it is possible to record a large capacity of 100 TB or more per magnetic recording cartridge.

The magnetic recording tape 10B is able to be suitably used in a recording/reproducing apparatus (a recording/reproducing apparatus for recording and reproducing data) including a ring-type recording head and a giant magnetoresistive (Giant Magnetoresistive: GMR) type or tunneling magnetoresistive (Tunneling Magnetoresistive: TMR) type reproducing head. In addition, for the magnetic recording tape 10B, a ring-type recording head is preferably used as a servo-signal writing head. On the magnetic layer 115, a data signal is perpendicularly recorded, for example, by a ring-type recording head. In addition, on the magnetic layer 115, a servo signal is perpendicularly recorded, for example, by a ring-type recording head.

The magnetic recording tape 10B is coupled to the leader tape 20 at the coupling part 4 in its own longitudinal direction. However, the magnetic recording tape 10B differs from the magnetic recording tape 10 of the first embodiment in that the magnetic recording tape 10B has the cross-sectional configuration illustrated in FIG. 14.

### (Substrate 111)

For the substrate 111, a substrate having substantially the same configuration as that of the substrate 11 in the magnetic recording tape 10 of the foregoing first embodiment may be used. Therefore, a detailed description of the substrate 111 is omitted.

### (SUL 112)

The SUL 112 includes a soft magnetic material in an amorphous state. The soft magnetic material includes, for example, at least one of a Co-based material or an Fe-based material. The Co-based material contains, for example, CoZNb, CoZrTa, or CoZrTaNb. The Fe-based material contains, for example, FeCoB, FeCoZr, or FeCoTa.

The SUL 112 has a single-layer structure, for example, and is provided directly on the substrate 111. The average thickness of the SUL 112 is preferably 10 nm or more and 50 nm or less, and more preferably 20 nm or more and 30 nm or less. The average thickness of the SUL 112 can be determined, for example, in the same manner as the method of measuring the average thickness of the magnetic layer 13 according to the first embodiment. It is to be noted that the average thicknesses of the layers other than the SUL 112, i.e., the average thicknesses of the first seed layer 113A, the second seed layer 113B, the first underlayer 114A, the second underlayer 114B, and the magnetic layer 115 can also be determined in the same manner as the method of measuring the average thickness of the magnetic layer 13.

### (First Seed Layer 113A and Second Seed Layer 113B)

The first seed layer 113A includes an alloy containing Ti and Cr, and contains a substance in an amorphous state. In addition, this alloy may further contain O (oxygen). This oxygen may be impurity oxygen contained in a small amount in the first seed layer 113A upon deposition of the first seed layer 113A by a deposition method such as a sputtering method. As used herein, the alloy means at least one of a solid solution, a eutectic, or an intermetallic compound containing Ti and Cr. In addition, the amorphous state means that halo is observed by an X-ray diffraction method, an electron beam diffraction method, or the like, thereby failing to identify a crystalline structure of a substance constituting the first seed layer 113.

The atomic ratio of Ti to the total amount of Ti and Cr contained in the first seed layer 113A is preferably 30 atomic % or more and less than 100 atomic %, and more preferably 50 atomic % or more and less than 100 atomic %. When the atomic ratio of Ti is less than 30%, (100) plane of a body-centered cubic lattice (Body-Centered Cubic lattice: bcc) structure of Cr is oriented, and there is a possibility that the orientations of the first underlayer 114A and the second underlayer 114B formed on the first seed layer 113A may be degraded.

The above-described atomic ratio of Ti is determined as follows. A depth profile analysis (depth profile measurement) of the first seed layer 113A is made by Auger electron spectroscopy (Auger Electron Spectroscopy: AES) while ion-milling the magnetic recording medium 110 from a side of the magnetic layer 115. Next, the average composition (average atomic ratio) of Ti and Cr in the film thickness direction is determined from the obtained depth profile. Next, the above-described atomic ratio of Ti is determined with the use of the obtained average composition of Ti and Cr.

In a case where the first seed layer 113A contains Ti, Cr, and O, the atomic ratio of O to the total amount of Ti, Cr, and O contained in the first seed layer 113A is preferably 15 atomic % or less, and more preferably 10 atomic % or less. When the atomic ratio of O exceeds 15 atomic %, generation of TiO₂ crystals affects the formation of crystal nuclei for the first underlayer 114A and the second underlayer 114B formed on the first seed layer 113A, and there is a possibility that the orientations of the first underlayer 114A and the second underlayer 114B may be degraded. The above-described atomic ratio of O is determined with the use of an analysis method similar to that for the above-described atomic ratio of Ti.

The alloy included in the first seed layer 113A may further contain elements other than Ti and Cr as additive elements. Examples of the additive elements may include one or more elements selected from the group consisting of Nb, Ni, Mo, Al, and W.

The average thickness of the first seed layer 113A is preferably 1 nm or more and 15 nm or less, and more preferably 1 nm or more and 10 m or less.

The second seed layer 113B contains, for example, NiW or Ta, and has a crystalline state. The average thickness of the second seed layer 113B is preferably 2 nm or more and 20 nm or less, and more preferably 3 nm or more and 15 nm or less.

The first seed layer 113A and the second seed layer 113B are not seed layers provided for the purpose of crystalline growth of the first underlayer 114A and the second underlayer 114B. The first seed layer 113A and the second seed layer 113B are seed layers that improve the vertical orientation of the first underlayer 114A and the second underlayer 114B.

### (First Underlayer 114A and Second Underlayer 114B)

The first underlayer 114A and the second underlayer 114B preferably have a crystalline structure similar to that of the magnetic layer 115. In a case where the magnetic layer 115 includes a Co-based alloy, the first underlayer 114A and the second underlayer 114B include a material having a hexagonal close-packed (hcp) structure similar to that of the Co-based alloy, and a c-axis of that structure is preferably oriented in a direction perpendicular to the film surface (i.e., in the film thickness direction). One reason for this is that the orientation of the magnetic layer 115 is able to be enhanced and that the lattice constant matching between the second underlayer 114B and the magnetic layer 115 is able to be made relatively favorable. As the material having the hexagonal close-packed (hcp) structure, it is preferable to use a material containing Ru, and specifically a Ru simple substance or a Ru alloy is preferred. Examples of the Ru alloy include Ru alloy oxides such as Ru—SiO₂, Ru—TiO₂, and Ru—ZrO₂; the Ru alloy may be one of those described above. As the material having the hexagonal close-packed (hcp) structure constituting the first underlayer 114A and the second underlayer 114B, there may be included, in addition to those described above, for example, a Co-based alloy such as Co_{(100-y)}Cr_{y} (where y is within the range of 35≤y≤45), or, for example, a non-magnetic oxide such as [Co_{(100-y)}Cr_{y}]_{(100-z)}(MO₂)_{z} (where y and z are in the ranges of 35≤y≤45 and z≤10, and M is Si or Ti).

As described above, similar materials can be used as the materials of the first underlayer 114A and the second underlayer 114B. The intended effect differs, however, for each of the first underlayer 114A and the second underlayer 114B. Specifically, the second underlayer 114B has a film structure that promotes a granular structure of the magnetic layer 115 which serves as an upper layer thereof, and the first underlayer 114A has a film structure with high crystalline orientation. In order to obtain such a film structure, the conditions for deposition such as sputtering conditions preferably differ for each of the first underlayer 114A and the second underlayer 114B.

The average thickness of the first underlayer 114A is preferably 3 nm or more and 15 nm or less, and more preferably 5 nm or more and 10 nm or less. The average thickness of the second underlayer 114B is preferably 7 nm or more and 100 nm or less, and more preferably 40 nm or more and 80 nm or less.

### (Magnetic Layer)

The magnetic layer (also referred to as a recording layer) 115 may be a perpendicular magnetic recording layer in which a magnetic material is vertically oriented. From the viewpoint of improving the recording density, the magnetic layer 115 is preferably a granular magnetic layer containing a Co-based alloy. This granular magnetic layer includes ferromagnetic crystalline particles containing a Co-based alloy and non-magnetic particle boundaries (non-magnetic material) that surround the ferromagnetic crystalline particles. More specifically, the granular magnetic layer includes columns (columnar crystals) containing a Co-based alloy, and non-magnetic particle boundaries (e.g., oxides such as SiO₂) that surround the columns and magnetically separate the columns. This structure can constitute the magnetic layer 115 that has a structure with the respective columns magnetically separated.

The Co-based alloy has a hexagonal close-packed (hcp) structure, and the c-axis thereof is oriented in a direction perpendicular to the film surface (film thickness direction). As the Co-based alloy, it is preferable to use a CoCrPt-based alloy containing at least Co. Cr, and Pt. The CoCrPt-based alloy may further contain an additive element. Examples of the additive element include one or more elements selected from the group consisting of Ni, Ta, and the like.

The non-magnetic particle boundaries that surround the ferromagnetic crystalline particles include a non-magnetic metal material. Here, the metal is considered to encompass semimetal. As the non-magnetic metal material, for example, at least one of a metal oxide or a metal nitride can be used; from the viewpoint of keeping the granular structure more stable, it is preferable to use a metal oxide. Examples of the metal oxide include a metal oxide containing at least one or more elements selected from the group consisting of Si, Cr, Co, Al, Ti, Ta, Zr, Ce, Y, Hf, and the like, and a metal oxide containing at least a Si oxide (i.e., SiO₂) is preferred. Specific examples of the metal oxide include SiO₂, Cr₂O₃, CoO, Al₂O₃, TiO₂, Ta₂O₅, ZrO₂, HfO₂, or the like. Examples of the metal nitride include a metal nitride containing at least one or more elements selected from the group consisting of Si, Cr, Co, Al, Ti, Ta, Zr, Ce, Y, Hf and the like. Specific examples of the metal nitride include SiN, TiN, AlN, or the like.

The CoCrPt-based alloy included in the ferromagnetic crystalline particles and the Si oxide included in the non-magnetic particle boundaries preferably have an average composition represented by the following formula (1). One reason for this is that it is possible to achieve a saturation magnetization amount Ms that is able to suppress the influence of the diamagnetic field and ensure a sufficient reproduced output, thereby making it possible to further achieve an improvement in the recording and reproducing characteristics.

$$( CoxPtyCr 100 - x - y ) 100 - z - ( {SiO}_{2} ) z \qquad ( 1 )$$

(In the formula (1), x, y, and z are values within the range of 69≤x≤75, 10≤ y≤16, and 9≤ z≤12.)

It is to be noted that the composition mentioned above is able to be determined as follows. A depth profile analysis of the magnetic layer 115 is made by AES while ion-milling the magnetic recording medium 110 from the side of the magnetic layer 115, thereby determining the average composition (average atomic ratio) of Co, Pt, Cr, Si, and O in the film thickness direction.

The average thickness tm [nm] of the magnetic layer 115 is preferably 9 nm ≤tm≤90 nm, more preferably 9 nm≤ tm≤20 nm, and still more preferably 9 nm≤ tm ≤15 nm. The average thickness tm of the magnetic layer 115 being within the above-mentioned numerical ranges makes it possible to improve the electromagnetic conversion characteristics.

In addition, the average particle volume of the magnetic powders of the magnetic layer 115 formed by a sputtering method is desirably 350 nm³ or more and 1800 nm³ or less. In order to determine the average particle volume of the magnetic powders of the magnetic layer 115, a surface of the magnetic layer 115 is first exposed by etching processing, and the surface is observed by TEM. From the observed image, a diameter R115 of the magnetic particles on the surface of the magnetic layer 115 is measured. Next, a cross-section of the magnetic layer 115 is formed by FIB, for example, and a thickness t115 is measured for the magnetic layer 115 from an image of the cross-section obtained by TEM. Thereafter, the particle volume is determined from the following expression.

$$( Particle volume ) = {( ( R 1 \; 15 ) / 2 )}^{2} \times π \times ( t 115 )$$

This is repeated for several locations to calculate an average value of particle volumes thereof.

### (Protective Layer)

The protective layer 116 includes, for example, a carbon material or silicon dioxide (SiO₂), and preferably includes a carbon material from the viewpoint of film strength of the protective layer 116. Examples of the carbon material include graphite, diamond-like carbon (Diamond-Like Carbon: DLC), diamond, or the like.

### (Lubricating Layer)

The lubricating layer 117 includes at least one lubricant. The lubricating layer 117 may further include various additives, e.g., rust inhibitors, or the like, as needed. The lubricant has at least two carboxyl groups and one ester bond, and includes at least one carboxylic acid compound represented by the following general formula (1). The lubricant may further include a lubricant of a type other than the carboxylic acid compound represented by the following general formula (1).

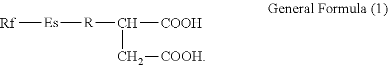

(In the formula, Rf denotes an unsubstituted or substituted, and saturated or unsaturated fluorine-containing hydrocarbon group or hydrocarbon group, μs denotes an ester bond, and R, which may be omitted, denotes an unsubstituted or substituted, and saturated or unsaturated hydrocarbon group.)

The above-described carboxylic acid compound is preferably represented by the following general formula (2) or (3).

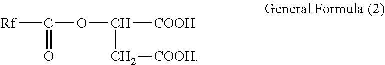

(In the formula, Rf denotes an unsubstituted or substituted, and saturated or unsaturated fluorine-containing hydrocarbon group or hydrocarbon group.)

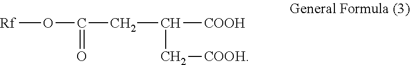

(In the formula, Rf denotes an unsubstituted or substituted, and saturated or unsaturated fluorine-containing hydrocarbon group or hydrocarbon group.)

The lubricant preferably includes one or both of the carboxylic acid compounds represented by the general formulae (2) and (3) mentioned above.

When the lubricant including the carboxylic acid compound represented by the general formula (1) is applied to the magnetic layer 115, the protective layer 116, or the like, a lubricating action is developed by cohesive force between fluorine-containing hydrocarbon groups or hydrocarbon groups Rf that are hydrophobic groups. In a case where the Rf group is a fluorine-containing hydrocarbon group, the total carbon number is preferably 6 to 50, and the total carbon number of the fluorinated hydrocarbon group is preferably 4 to 20. The Rf group may be, for example, a saturated or unsaturated, and linear, branched, or cyclic hydrocarbon group, but may preferably be a saturated linear hydrocarbon group.

For example, in a case where the Rf group is a hydrocarbon group, the Rf group is desirably a group represented by the following general formula (4).

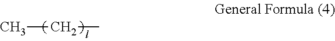

(In the general formula (4), 1 denotes an integer selected from the range of 8 to 30, more desirably 12 to 20.)

In addition, in a case where the Rf group is a fluorine-containing hydrocarbon group, the Rf group is desirably a group represented by the following general formula (5).

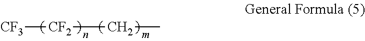

(In the general formula (5), m and n each denote an integer selected, independently of each other, from the following ranges: m=2 to 20, n=3 to 18, more desirably m=4 to 13, n=3 to 10.)

The fluorinated hydrocarbon group may be concentrated on one site within a molecule as mentioned above, or dispersed as in the following general formula (6), and may be not only —CF₃ or —CF₂—, but also —CHF₂, —CHF—, or the like.

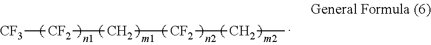

(In the general formulae (5) and (6), n1+n2=n, m1+m2=m.)

The carbon numbers are limited as mentioned above in the general formulae (4), (5), and (6), because when the number of carbon atoms constituting the alkyl group or the fluorine-containing alkyl group (l, or the sum of m and n) is equal to or more than the lower limit mentioned above, the length of the group reaches an appropriate length, thereby effectively exhibiting the cohesive force between the hydrophobic groups, developing a favorable lubricating action, and improving friction/abrasion durability. In addition, one reason for this is that, when the number of carbon atoms is equal to or less than the upper limit mentioned above, the solubility of the lubricant including the carboxylic acid compound mentioned above in a solvent is kept favorable.

In particular, the Rf group in the general formulae (1), (2), and (3) is, when the group contains a fluorine atom, effective for a reduction in a friction coefficient, an improvement in traveling performance, and the like. It is, however, preferable to provide a hydrocarbon group between the fluorine-containing hydrocarbon group and the ester bond, thereby, with the space between the fluorine-containing hydrocarbon group and the ester bond, ensuring the stability of the ester bond for prevention of hydrolysis.

In addition, the Rf group may have a fluoroalkyl ether group or a perfluoropolyether group.

The R group in the general formula (1) may be omitted, but, if any, is preferably a hydrocarbon chain having a relatively small number of carbon atoms.

In addition, the Rf group or the R group contains, as a constituent element, one or a plurality of elements selected from nitrogen, oxygen, sulfur, phosphorus, and halogen, and may further have, in addition to the already described functional groups, a hydroxyl group, a carboxyl group, a carbonyl group, an amino group, an ester bond, or the like.

Specifically, the carboxylic acid compound represented by the general formula (1) is preferably at least one of the following compounds. That is, the lubricant preferably contains at least one of the following compounds.
CF₃(CF₂)₇(CH₂)COOCH(COOH)CH₂COOH
CF₃(CF₂)₃(CH₂)₁₀COOCH(COOH)CH₂COOH
C₁₇H₃₅COOCH(COOH)CH₂COOH
CF₃(CF₂)₇(CH₂)₂OCOCH₂CH(C₁₈H₃₇)COOCH(COOH)CH₂COOH
CF₃(CF₂)₇COOCH(COOH)CH₂COOH
CHF₂(CF₂)₇COOCH(COOH)CH₂COOH
CF₃(CF₂)₇(CH₂)₂OCOCH₂CH(COOH)CH₂COOH
CF₃(CF₂)₇(CH₂)₆OCOCH₂CH(COOH)CH₂COOH
CF₃(CF₂)₇(CH₂)₁₁OCOCH₂CH(COOH)CH₂COOH
CF₃(CF₂)₃(CH₂)₆OCOCH₂CH(COOH)CH₂COOH
C₁₈H₃₇OCOCH₂CH(COOH)CH₂COOH
CF₃(CF₂)₇(CH₂)₄COOCH(COOH)CH₂COOH
CF₃(CF₂)₃(CH₂)₄COOCH(COOH)CH₂COOH
CF₃(CF₂)₃(CH₂)₇COOCH(COOH)CH₂COOH
CF₃(CF₂)₃(CH₂)₁₀COOCH(COOH)CH₂COOH
CF₃(CF₂)₇(CH₂)₁₂COOCH(COOH)CH₂COOH
CF₃(CF₂)₅ (CH₂)₁₀COOCH(COOH)CH₂COOH
CF₃(CF₂)₇CH(C₉H₁₉)CH₂CH═CH(CH₂)₇COOCH(COOH)CH₂COOH
CF₃(CF₂)₇CH(C₆H₁₃)(CH₂)₇COOCH(COOH)CH₂COOH
CH₃(CH₂)₃(CH₂CH₂CH(CH₂CH₂(CF₂)₉CF₃))₂(CH₂)₇COOCH(COOH)CH₂COOH

The carboxylic acid compound represented by the general formula (1), which is soluble in a non-fluorine solvent exerting a low burden on the environment, has the advantage of, for example, allowing for operations such as coating, dipping, and spraying to be performed with the use of a general-purpose solvent such as a hydrocarbon-based solvent, a ketone-based solvent, an alcohol-based solvent, and an ester-based solvent. Specifically, examples of the general-purpose solvent can include solvents such as hexane, heptane, octane, decane, dodecane, benzene, toluene, xylene, cyclohexane, methyl ethyl ketone, methyl isobutyl ketone, methanol, ethanol, isopropanol, diethyl ether, tetrahydrofuran, dioxane, and cyclohexanone.

In a case where the protective layer 116 includes a carbon material, application of the carboxylic acid compound mentioned above as a lubricant onto the protective layer 116 allows two carboxyl groups and at least one ester linking group, which serve as polar group sites of a lubricant molecule, to be adsorbed onto the protective layer 116, thereby enabling the cohesive force between the hydrophobic groups to form the lubricating layer 117 which particularly has favorable durability.

It is to be noted that the lubricant is not only held as the lubricating layer 117 on the surface of the magnetic recording tape 10B as described above, but may also be included and held in the layers such as the magnetic layer 115 and the protective layer 116 constituting the magnetic recording tape 10B.

### (Back Layer)

The back layer 118 may have a configuration similar to that of the back layer 14 according to the first embodiment.

All of the physical properties of the magnetic recording tape 10 and the measurement method thereof described in the foregoing first embodiment are applicable to the physical properties of the magnetic recording tape 10B and the measurement method thereof of the present embodiment. For example, the average thickness of the magnetic recording tape 10B and the measurement method thereof are similar to the average thickness of the magnetic recording tape 10B and the measurement method thereof. The same applies to parameters representing other physical properties such as the coercivity Hc, the squareness ratio, and a moisture content rate WA.

### [2-3. Configuration of Sputtering Apparatus]

Hereinafter, a description is given, with reference to FIG. 15, of an example of a configuration of a sputtering apparatus 120 for use in the manufacture of the magnetic recording tape 10B. The sputtering apparatus 120 is a continuous winding-type sputtering apparatus for use in deposition of the SUL 112, the first seed layer 113A, the second seed layer 113B, the first underlayer 114A, the second underlayer 114B, and the magnetic layer 115. The sputtering apparatus 120 includes, as illustrated in FIG. 14, a deposition chamber 121, a drum 122 which is a metal can (rotating body), cathodes 123a to 123f, a supply reel 124, a wind-up reel 125, and a plurality of guide rollers 127a to 127c and 128a to 128c. The sputtering apparatus 120 is, for example, a DC (direct current) magnetron sputtering-type apparatus, but the sputtering type is not limited to this type.

The deposition chamber 121 is coupled to an unillustrated vacuum pump via an exhaust port 126, and the atmosphere in the deposition chamber 121 is set by the vacuum pump to a predetermined degree of vacuum. The drum 122 having a rotatable configuration, the supply reel 124, and the wind-up reel 125 are disposed inside the deposition chamber 121. Inside the deposition chamber 121, the plurality of guide rollers 127a to 127c is provided for guiding the transfer of a base layer 111 between the supply reel 124 and the drum 122, and the plurality of guide rollers 128a to 128c is provided for guiding the transfer of the base layer 111 between the drum 122 and the wind-up reel 125. Upon sputtering, the base layer 111 unwound from the supply reel 124 is wound around the wind-up reel 125 via the guide rollers 127a to 127c, the drum 122, and the guide rollers 128a to 128c. The drum 122 has a cylindrical shape, and the elongated base layer 111 is transferred along the circumferential cylindrical surface of the drum 122. The drum 122 is provided with an unillustrated cooling mechanism, and cooled to, for example, about −20° C. upon sputtering. Inside the deposition chamber 121, the plurality of cathodes 123a to 123f is disposed to face the circumferential surface of the drum 122. Respective targets are set on these cathodes 123a to 123f. Specifically, the respective targets for depositing the SUL 112, the first seed layer 113A, the second seed layer 113B, the first underlayer 114A, the second underlayer 114B, and the magnetic layer 115 are set for the cathodes 123a, 123b, 123c, 123d, 123e, and 123f. With these cathodes 123a to 123f, multiple kinds of films, i.e., the SUL 112, the first seed layer 113A, the second seed layer 113B, the first underlayer 114A, the second underlayer 114B, and the magnetic layer 115 are simultaneously deposited.

The sputtering apparatus 120 having the above-described configuration is able to continuously deposit, by a roll-to-roll method, the SUL 112, the first seed layer 113A, the second seed layer 113B, the first underlayer 114A, the second underlayer 114B, and the magnetic layer 115.

### [2-4. Method of Manufacturing Magnetic Recording Tape 10B]

The magnetic recording tape 10B may be manufactured, for example, as follows.

First, the sputtering apparatus 120 illustrated in FIG. 15 is used to deposit the SUL 112, the first seed layer 113A, the second seed layer 113B, the first underlayer 114A, the second underlayer 114B, and the magnetic layer 115 sequentially on a front surface of the base layer 111. Specifically, the deposition is performed as follows. First, the deposition chamber 121 is vacuumed until reaching a predetermined pressure. Thereafter, the targets set on the cathodes 123a to 123f are sputtered while introducing a process gas such as an Ar gas into the deposition chamber 121. This allows the SUL 112, the first seed layer 113A, the second seed layer 113B, the first underlayer 114A, the second underlayer 114B, and the magnetic layer 115 to be sequentially deposited on the front surface of the traveling base layer 111.

The atmosphere of the deposition chamber 121 upon sputtering is set to, for example, about 1×10⁻⁵ Pa to 5×10⁻⁵ Pa. It is possible to control the film thicknesses and characteristics of the SUL 112, the first seed layer 113A, the second seed layer 113B, the first underlayer 114A, the second underlayer 114B, and the magnetic layer 115 by adjusting the tape line speed at which the base layer 111 is wound up, the pressure (sputtering gas pressure) of a process gas such as an Ar gas to be introduced upon sputtering, input power, and the like.

Next, the protective layer 116 is deposited on the magnetic layer 115. As a method of depositing the protective layer 116, for example, a chemical vapor deposition (Chemical Vapor Deposition: CVD) method or a physical vapor deposition (Physical Vapor Deposition: PVD) method can be used.

Next, a coating material for back layer deposition is prepared by kneading and dispersing a binder, inorganic particles, a lubricant, and the like in a solvent. Next, the back layer 118 is deposited on a back surface of the base layer 111 by applying a coating material for back layer deposition on the back surface of the base layer 111 and drying the coating material.

Next, for example, a lubricant is applied onto the protective layer 116 to deposit the lubricating layer 117. As a method of applying the lubricant, various coating methods can be used, such as gravure coating and dip coating, for example. Next, the magnetic recording tape 10B is cut to have a predetermined width, as needed. Thus, the magnetic recording tape 10B illustrated in FIG. 14 is obtained.

### [2-5. Effects]

Also in the present embodiment, the use of the leader tape 20 makes it possible to reduce bending, depression, or the like transferred onto the surface of the magnetic recording tape 10B. It is therefore possible to favorably perform the above without hindering the information recording operation on the magnetic recording tape 10B or the information reading operation from the magnetic recording tape 10B.

### [2-6. Modification Example]

The magnetic recording tape 10B may further include an underlayer between the substrate 111 and the SUL 112. The SUL 112 has an amorphous state, and thus has no role in promoting epitaxial growth of a layer formed on the SUL 112. However, the SUL 112 is required not to disturb the crystalline orientations of the first underlayer 114A and the second underlayer 114B formed on the SUL 112. To that end, the soft magnetic material preferably has a fine structure that forms no column. However, in a case of being largely affected by degassing of moisture or the like from the substrate 111, there is a possibility that the soft magnetic material may be coarsened, thereby disturbing the crystalline orientations of the first underlayer 114A and the second underlayer 114B formed on the SUL 112. In order to suppress the influence of the degassing of moisture or the like from the substrate 111, it is preferable to provide, between the substrate 111 and the SUL 112, an underlayer that includes an alloy containing Ti and Cr and has an amorphous state, as described above. As a specific configuration of the underlayer, a configuration can be adopted which is similar to that of the first seed layer 113A.

The magnetic recording tape 10B may not include at least one of the second seed layer 113B or the second underlayer 114B. From the viewpoint of improving the SNR, however, it is more preferable to include both of the second seed layer 113B and the second underlayer 114B.

The magnetic recording tape 10B may include an APC-SUL (Antiparallel Coupled SUL) instead of the SUL 112 of the single-layer structure.

### 3. EXAMPLES

Hereinafter, a specific description is given of the present disclosure with reference to examples. However, the present disclosure is not limited to only these examples.

In the following examples and comparative examples, the maximum step difference ΔT of the leader tape is a value determined by the measuring method described in the foregoing first embodiment.

### Example 1

A magnetic recording medium as Example 1 was obtained as follows.

First, a magnetic recording tape was produced as follows.

### (Preparation Step of Coating Material for Forming Magnetic Layer)

The coating material for forming a magnetic layer was prepared as follows. First, a first composition of the following formulation was kneaded by an extruder. Next, the kneaded first composition and a second composition of the following formulation were added to a stirring tank equipped with a disperser to perform preliminary mixing. Subsequently, Dyno-mill mixing was further performed, and filter treatment was performed to prepare the coating material for forming a magnetic layer.

### (First Composition)

Components and weights in the first composition are as follows.
Powder of barium ferrite (BaFe₁₂O₁₉) particles (hexagonal plate, average aspect ratio 3.0, average particle volume 1600 nm³): 100 parts by mass
50 parts by mass of cyclohexanone solution of a vinyl chloride resin
   (The composition of the solution is as follows: resin content 30% by mass and cyclohexanone 70% by mass. The detail of the vinyl chloride resin was as follows: degree of polymerization 300, Mn=10000, containing, as polar groups, OSO₃K=0.07 mmol/g and secondary OH=0.3 mmol/g
Aluminum oxide powder (α-Al₂O₃, average particle diameter 0.1 μm): 5 parts by mass

### (Second Composition)

Components and weights in the second composition are as follows.
Carbon black: 2 parts by mass (manufactured by Tokai Carbon Co., Ltd., trade name: Seast TA)
Polyurethane resin (Resin solution: polyurethane resin blending amount 30% by mass, cyclohexanone blending amount 70% by mass): 5.56 parts by mass
(Polyurethane resin: number average molecular weight Mn=25000, Tg 110° C.)
n-Butyl stearate as fatty acid ester: 2 parts by mass
Methyl ethyl ketone: 121.3 parts by mass
Toluene: 121.3 parts by mass
Cyclohexanone: 60.7 parts by mass

4 parts by mass of polyisocyanate (trade name: Coronate L, manufactured by Tosoh Corporation) as a curing agent and 2 parts by mass of stearic acid as fatty acid were added to the coating material for forming a magnetic layer prepared as described above.

### <Preparation Step of Coating Material for Forming Underlayer>

A coating material for forming an underlayer was prepared as follows. First, a third composition of the following formulation was kneaded with an extruder. Next, the kneaded third composition and a fourth composition of the following formulation were added to a stirring tank equipped with a disperser to perform preliminary mixing. Subsequently, Dyno-mill mixing was further performed, and filter treatment was performed to prepare the coating material for forming an underlayer.

### (Third Composition)

Components and weights in the third composition are as follows.
Acicular iron oxide powder (α-Fe₂O₃, average major axis length 0.12 μm): 100 parts by mass
Vinyl chloride-based resin (Resin solution: resin content 30% by mass, cyclohexanone 70% by mass): 46 parts by mass
   (Polyurethane resin: number average molecular weight Mn=25000, Tg 110° C.)

### (Fourth Composition)

Components and weights in the fourth composition are as follows.
Carbon black (Average particle diameter 20 nm): 20 parts by mass
Polyurethane resin (Resin solution: resin content 30% by mass, cyclohexanone 70% by mass): 37 parts by mass
(Polyurethane resin: number average molecular weight Mn=25000, Tg 110° C.)
n-Butyl stearate as fatty acid ester: 2 parts by mass
Methyl ethyl ketone: 108.2 parts by mass
Toluene: 108.2 parts by mass
Cyclohexanone: 18.5 parts by mass

2.49 parts by mass of polyisocyanate (trade name: Coronate L, manufactured by Tosoh Corporation) as a curing agent and 2 parts by mass of stearic acid as fatty acid were added to the coating material for forming an underlayer prepared as described above.

### <Preparation Step of Coating Material for Forming Back Layer>

A coating material for forming a back layer was prepared as follows. The following raw materials were mixed in a stirring tank equipped with a disperser, and subjected to filter treatment to prepare a coating material for forming a back layer.
Carbon black (manufactured by Asahi Carbon Co., Ltd., trade name: #80): 100 parts by mass
Polyester polyurethane (Trade name: N-2304, manufactured by Tosoh Corporation): 100 parts by mass
Methyl ethyl ketone: 500 parts by mass
Toluene: 400 parts by mass
Cyclohexanone: 100 parts by mass
Polyisocyanate (trade name: Coronate L, manufactured by Tosoh Corporation): 10 parts by mass

### <Application Step>

The coating material for forming a magnetic layer and the coating material for forming an underlayer prepared as described above were used to form an underlayer having an average thickness of 0.92 μm and a magnetic layer having an average thickness of 80 nm on one main surface of an elongated polyester film having an average thickness 4.0 μm, which is a non-magnetic support, as follows. First, the coating material for forming an underlayer was applied onto one main surface of the polyester film and dried to thereby form an underlayer. Next, the coating material for forming a magnetic layer was applied onto the underlayer and dried to thereby form a magnetic layer. It is to be noted that a weight ratio between the vinyl chloride-based resin and the polyurethane-based resin in the binder of the magnetic layer was set to 1:1. In addition, when drying the coating material for forming a magnetic layer, the magnetic field of the magnetic powders was oriented in a thickness direction of the film by a solenoidal coil. The squareness ratio of the magnetic recording medium in the thickness direction (vertical direction) was set to 67%. Subsequently, the coating material for forming a back layer was applied onto the other main surface of the polyester film and dried to thereby form a back layer having an average thickness of 0.3 μm. This allowed a magnetic recording medium to be obtained.

### <Calendering Step and Transfer Step>

Subsequently, calendering processing was performed to planarize a surface of the magnetic layer. Next, a magnetic recording tape in which the surface of the magnetic layer was planarized was wound up into a roll shape, and thereafter a heating treatment was performed on the magnetic recording tape in that state at 60° C. for 10 hours. Then, the magnetic recording tape was rewound into a roll shape to allow the end thereof positioned on the inner circumferential side to be positioned reversely on the outer circumferential side, and thereafter a heating treatment was performed again on the magnetic recording tape in that state at 60° C. for 10 hours.

### <Cutting Step>

The magnetic recording tape obtained as described above was cut to have a width of ½ inches (12.65 mm). Thus, an intended elongated magnetic recording tape (average thickness: 5.2 μm) was obtained. It is to be noted that the length of the magnetic recording tape in the longitudinal direction was set to 1035 m.

Next, the leader tape as Example 1 to be coupled to the magnetic recording tape of Example 1 obtained as described above was produced as follows.

### (Preparation Step of Coating Material for Forming Magnetic Layer)

The coating material for forming a magnetic layer was prepared as follows.

### (First Composition)

Acicular metal magnetic powder (Acicular ratio: 6.0, average particle volume V: 5000 nm³): 100 parts by mass
Vinyl chloride-based resin (Cyclohexanone solution 30% by mass): 35.0 parts by mass (Degree of polymerization 300, Mn=10000, containing, as polar groups, OSO₃K=0.07 mmol/g and secondary OH=0.3 mmol/g)
Polyurethane-based resin (Resin solution: resin content 30% by mass, cyclohexanone 70% by mass): 32 parts by mass
(Polyurethane resin: number average molecular weight Mn=25000, Tg 110° C.)
Carbon black: 3 parts by mass (manufactured by Tokai Carbon Co., Ltd., trade name: Seast TA)
Aluminum oxide powder: 5 parts by mass (α-Al₂O₃, average particle diameter 0.1 μm)
n-Butyl stearate: 2 parts by mass
Methyl ethyl ketone: 121.3 parts by mass
Toluene: 121.3 parts by mass
Cyclohexanone: 60.7 parts by mass

Finally, as a curing agent, 4 parts by mass of polyisocyanate (trade name: Coronate L, manufactured by Nippon Polyurethane Industry Co., Ltd.) and 2 parts by mass of myristic acid were added to the coating material for forming a magnetic layer prepared as described above.

### (Preparation Step of Coating Material for Forming Underlayer)

A coating material for forming an underlayer was prepared as follows. First, a third composition of the following formulation was kneaded with an extruder. Next, the kneaded third composition and a fourth composition of the following formulation were added to a stirring tank equipped with a disperser to perform preliminary mixing. Subsequently, Dyno-mill mixing was further performed, and filter treatment was performed to prepare the coating material for forming an underlayer.

### (Third Composition)

Acicular iron oxide powder: 100 parts by mass (α-Fe₂O₃, average major axis length 0.12 μm)
Vinyl chloride-based resin: 46 parts by mass (Resin solution: resin content 30% by mass, cyclohexanone 70% by mass)

### (Fourth Composition)

Carbon black: 20 parts by mass (Average particle diameter 20 nm)
Polyurethane-based resin (Resin solution: resin content 30% by mass, cyclohexanone 70% by mass): 37 parts by mass
(Polyurethane resin: number average molecular weight Mn=25000, Tg 110° C.)
n-Butyl stearate: 2 parts by mass
Methyl ethyl ketone: 108.2 parts by mass
Toluene: 108.2 parts by mass
Cyclohexanone: 18.5 parts by mass

Finally, as a curing agent, 2.49 parts by mass of polyisocyanate (trade name: Coronate L, manufactured by Nippon Polyurethane Industry Co., Ltd.) and 2 parts by mass of myristic acid were added to the coating material for forming an underlayer prepared as described above.

### (Preparation Step of Coating Material for Forming Back Layer)

A coating material for forming a back layer was prepared as follows. The following raw materials were mixed in a stirring tank equipped with a disperser, and subjected to filter treatment to prepare the coating material for forming a back layer.
Carbon black (manufactured by Asahi Carbon Co., Ltd., trade name: #80): 100 parts by mass
Polyester polyurethane: 100 parts by mass (manufactured by Nippon Polyurethane Industry Co., Ltd., trade name: N-2304)
Methyl ethyl ketone: 500 parts by mass
Toluene: 400 parts by mass
Cyclohexanone: 100 parts by mass
Polyisocyanate (trade name: Coronate L, manufactured by Tosoh Corporation): 10 parts by mass

### (Deposition Step)

The coating material produced as described above was used to form, on a base film, an underlayer and a magnetic layer as follows. It is to be noted that an elongated polyester film having an average thickness of 15.0 μm was used for the base film. First, the coating material for forming an underlayer was applied onto the base film and dried to thereby form an underlayer on the base film. Next, the coating material for forming a magnetic layer was applied onto the underlayer and dried to thereby form a magnetic layer on the underlayer. It is to be noted that, when drying the coating material for forming a magnetic layer, the magnetic field of the magnetic powders was oriented in the thickness direction of the film by a solenoidal coil. In addition, the time of applying the magnetic field to the coating material for forming a magnetic layer was adjusted to set the squareness ratio S2 in the thickness direction (vertical direction) of the magnetic recording medium to 65%. In addition, the underlayer was formed to have a final average thickness of 1.5 μm. The magnetic layer was formed to have a final average thickness of 0.2 μm.

Subsequently, a back layer was applied to the base film with the underlayer and the magnetic layer formed thereon, and dried. Then, the base film with the underlayer, the magnetic layer, and the back layer formed thereon was subjected to curing treatment. Subsequently, calendering processing was performed to planarize the surface of the magnetic layer. Further, re-curing treatment was performed to obtain a leader tape having an average thickness of 17.0 μm. It is to be noted that the back layer was formed to have a final average thickness of 0.50 μm.

### (Cutting Step)

The leader tape obtained as described above was cut to have a width of ½ inches (12.65 mm). Thus, an intended elongated leader tape (average thickness: 17.0 μm) was obtained as Example 1. It is to be noted that the length of the leader tape in the longitudinal direction was set to 4500 mm. Finally, the magnetic recording tape as Example 1 produced separately and the leader tape as Example 1 were coupled to each other to thereby obtain the magnetic recording medium of Example 1.

The obtained magnetic recording medium of Example 1 was caused to travel under the above-described certain conditions, and then the leader tape was collected from the magnetic recording medium to measure the maximum step difference ΔT of a stepped part of the leader tape. The results are exhibited in Table 1. It is to be noted that the confirmation position [m] in Table 1 indicates a position of the leader tape from the beginning in the longitudinal direction.

TABLE 1

| | Leader Tape | | | | | | | Error Rate | PES [mm] | |
|---|---|---|---|---|---|---|---|---|---|---|
| | Underlayer | | | | | | | After | After | After |
| | Thickness | Length | Confirmation Position [mm] | | | | | Writing | Writing | Writing |
| | [μm] | [mm] | 400 | 800 | 1500 | 3000 | 4400 | Once | Once | 20 Times |
| Example 1 | 1.5 | 4500 | 43 | 39 | 35 | 22 | 17 | 600 | 31 | 44 |
| Example 2 | 1.3 | 4500 | 44 | 39 | 37 | 28 | 25 | 600 | 30 | 53 |
| Example 3 | 1.1 | 4500 | 45 | 43 | 40 | 38 | 34 | 600 | 34 | 60 |
| Comparative | 1.5 | 900 | 43 | 39 | — | — | — | 400 | 56 | 120 |
| Example 1 | | | | | | | | | | |
| Comparative | 1.3 | 900 | 44 | 42 | — | — | — | 400 | 58 | 101 |
| Example 2 | | | | | | | | | | |
| Comparative | 1.1 | 900 | 46 | 44 | — | — | — | 400 | 55 | 134 |
| Example 3 | | | | | | | | | | |

It is to be noted that Table 1 also exhibits the error rate and PES. The error rate as used herein refers to Error Correcting Code (ECC) described in Ecma International standard “Standard ECMA-319 Data Interchange on 12.7 mm 384-Track Magnetic Tape Cartridges-Ultrium-1 Format” (https://www.ecma-international.org/wp-content/uploads/ECMA-319 #1st #edition #june #2001.pdf). The error rate was evaluated by a method described in the ECMA-319 using a full height drive for LTO 9.

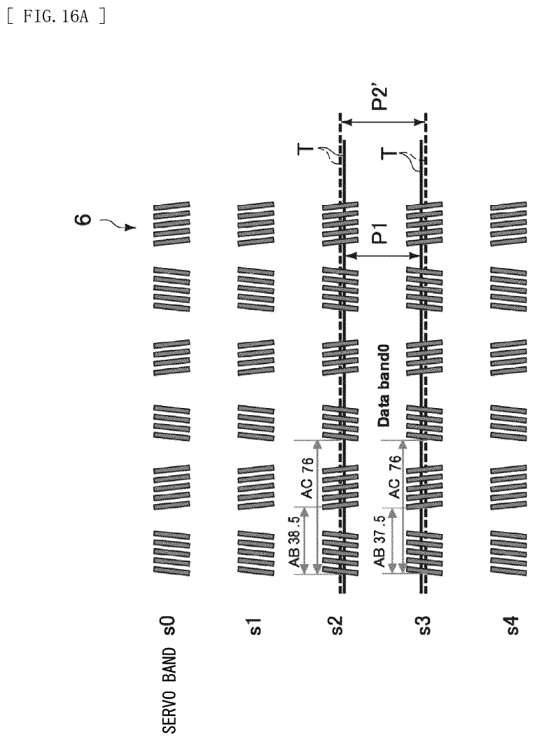

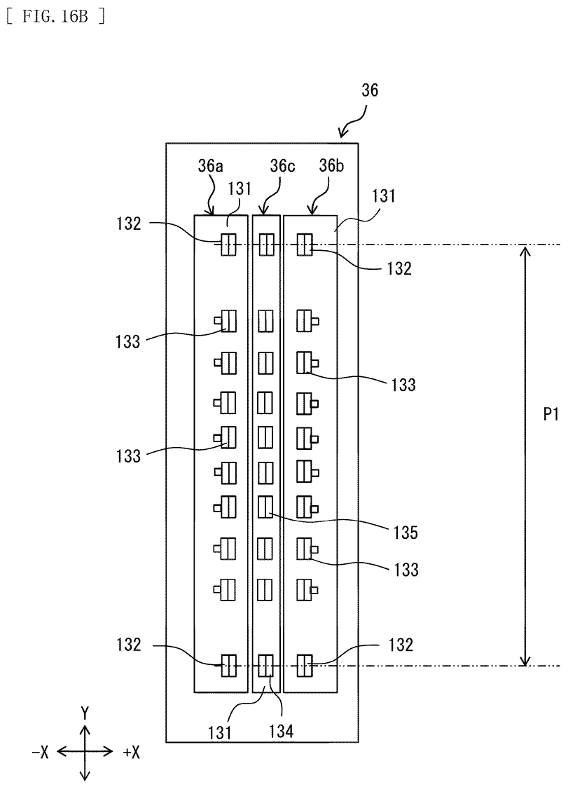

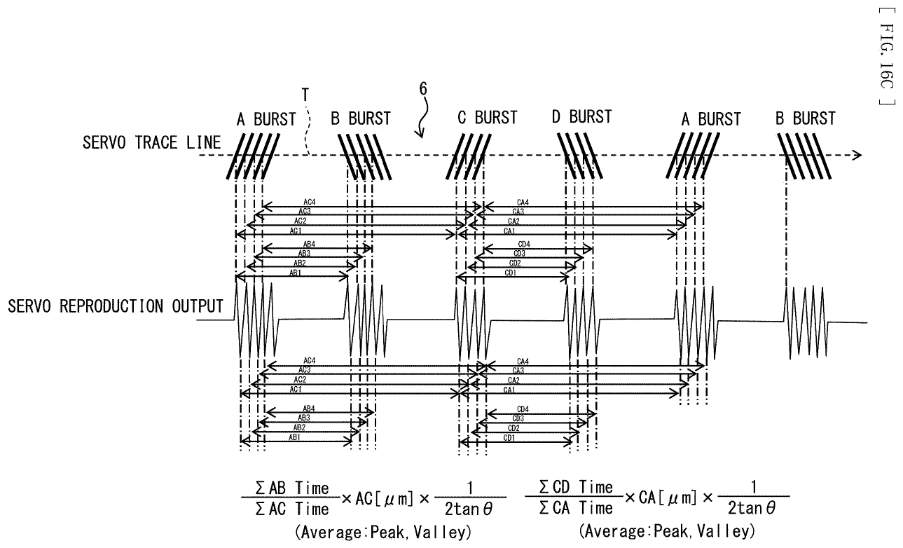

Next, a description is given of PES with reference to FIGS. 16A to 16C. FIG. 16A is an explanatory diagram of a method of measuring PES using the recording/reproducing apparatus in FIG. 11. FIG. 16B is an outline diagram of the head unit 36 of the recording/reproducing apparatus 30. The head unit 36 includes, for example, two servo lead heads, a plurality of data write heads, and the like. FIG. 16B is an outline diagram of the head unit 36 as viewed from a lower side (tape-traveling surface). As illustrated in FIG. 16B, the head unit 36 includes a first drive head section 36a, a second drive head section 36b, and a third drive head section 36c. The first drive head section 36a and the second drive head section 36b are symmetrically configured in an X-axis direction which is a traveling direction of the magnetic recording medium TM. The third drive head section 36c is disposed between the first drive head section 36a and the second drive head section 36b in the X-axis direction. The first to third drive head sections 36a to 36c are configured to be movable in a Y-axis direction which is a width direction of a magnetic recording medium TM1.

The first drive head section 36a is a drive head to be used when the magnetic recording medium TM travels in a forward direction, i.e., in a +X direction. Meanwhile, the second drive head section 36b is a drive head to be used when the magnetic recording tape 10 travels in a reverse direction, i.e., in a −X direction. Because the first drive head section 36a and the second drive head section 36b basically have similar configurations, a description is given of the first drive head section 36a in a representative manner.

The first drive head section 36a includes a head main body 131, two servo lead heads 132, and a plurality of data write heads 133.

The servo lead heads 132 are provided one by one respectively at both end sides of the head main body 131 in the width direction (Y-axis direction). A tunnel magneto resistive element (TMR: Tunnel Magneto Resistive effect), or the like is included as an MR element. An interval between the two servo lead heads 132 in the width direction (Y-axis direction) is favorably the same substantially as a distance between adjacent servo bands s in the magnetic recording medium TM.

The data write heads 133 are arranged at an equal interval along the width direction (Y-axis direction). In addition, the data write head 133 is arranged at a position sandwiched by the two servo lead heads 132. The number of the data write heads 133 is, for example, about 20 to 40, but the number is not particularly limited. The data write head 133 is configured to be able to record data signals on a data band d of the magnetic recording tape 10 by a magnetic field generated from a magnetic gap.

The third drive head section 36c includes, for example, the head main body 131, two servo heads 134, and a plurality of data read heads 135. The data read head 135 is configured to be able to reproduce data signals by causing an MR element or the like to read a magnetic field generated from magnetic information recorded in the data band d of the magnetic recording medium TM. The tunnel magneto resistive element (TMR: Tunnel Magneto Resistive effect), or the like is included as the MR element.

The first drive head section 36a is disposed on the left side of the third drive head section 36c, i.e., on an upstream side in a case where the magnetic recording medium TM flows in the forward direction. Meanwhile, the second drive head section 36b is disposed on the right side of the third drive head section 36c, i.e., in an upstream side in a case where the magnetic recording medium TM flows in the reverse direction. It is to be noted that the data read head 135 of the third drive head section 36c is able to reproduce data signals immediately after the data signals are written into the magnetic recording medium TM by the first drive head section 36a or the second drive head section 36b.

The PES as used herein is a numerical value representing a relative position, with respect to a servo pattern 6, of a servo trace line T on each of the servo bands of the two servo lead heads 132 (FIG. 16B) at the time when the recording/reproducing apparatus 30 causes the magnetic recording medium TM to travel across the entire length. An interval between the servo trace lines T indicated by solid lines in FIG. 16A indicates a servo band pitch at the time when a width of the magnetic recording medium TM is not changed, i.e., a first pitch P1 which is an arrangement interval between the two servo lead heads 132 of the head unit 36. In addition, an interval between the servo trace lines T indicated by broken lines in FIG. 16A corresponds to a servo band pitch P2′ at the time when the width of the magnetic recording medium TM is widened.

FIG. 16C is an explanatory diagram of a method of measuring the servo trace line T. The magnetic recording/reproducing apparatus 30 outputs a corrugated servo reproduction signal corresponding to a position of the servo trace line T with respect the servo pattern 6. Typically, a distance AC between an A burst and a C burst, which are arrangements of an inclined pattern of the same type of shape, and a distance AB between the A burst and a B burst, which are arrangements of inclined patterns of different types of shapes, are calculated. Then, a numerical value representing a relative position of the servo trace line T of each of the servo lead heads 132 with respect to the servo pattern 6 is calculated by the expression indicated by the following [Mathematical Expression 5]. It is to be noted that θ is an azimuth angle of each of the inclined patterns described above, and θ is 12° in this example. In addition, the distance AC is calculated by multiplying AC Time by a tape-traveling speed. Here, the AC Time means time from A signal to C signal. In a case where the AC Time is measured from a measurement using a large number of servo frames, an arithmetic average value of the AC Time is multiplied by the tape-traveling speed for the calculation thereof. Likewise, the distance AB is calculated by multiplying AB Time by the tape-traveling speed. Here, the AB Time means time from the A signal to B signal. It is to be noted that, in the following [Mathematical Expression 1], ΣAB Time and ΣAC Time mean respective integrated values of the AB Time and the AC Time in 100100000 pieces of servo frames. In the expression of [Mathematical Expression 5], in a case where the AB Time is defined as time when a servo reproduction waveform between first inclined parts has a peak upon calculation of (ΣAB Time/ΣAC Time), the AC Time is also defined as the time when the servo reproduction waveform between the first inclined parts has a peak. In a case where the AB Time is defined as time when a servo reproduction waveform between second inclined parts has a peak, the AC Time is also defined as the time when the servo reproduction waveform between the second inclined parts has a peak. In a case where the AB Time is defined as time when a servo reproduction waveform between third inclined parts has a peak, the AC Time is also defined as the time when the servo reproduction waveform between the third inclined parts has a peak. In a case where the AB Time is defined as time when a servo reproduction waveform between fourth inclined parts has a peak, the AC Time is also defined as the time when the servo reproduction waveform between the fourth inclined parts has a peak.

It is to be noted that the position of T is a position where (Σ AB Time/Σ AC Time) is 1.

$$\frac{\sum AB Time}{\sum AC Time} \times AC [ μ m ] \times \frac{1}{2 tan θ} \qquad [ Mathematical Expression 5 ]$$

Here, the distance AC may be a distance AC1 between the first inclined parts of the A burst and the C burst; the distance AC may be a distance AC2 between the second inclined parts thereof; the distance AC may be a distance AC3 between the third inclined parts thereof; or the distance AC may be a distance AC4 between the fourth inclined parts thereof. These distances AC (AC1 AC4) each refer to a distance calculated by multiplying time between (upper peak) timings when amplitude indicates a positive maximum value in the servo reproduction waveform, by the tape-traveling speed.

It is to be noted that, in the present Example, the PES was measured using an LTO-9 drive servo-characteristics evaluation apparatus.

### Example 2

A magnetic recording medium of Example 2 was produced in the same manner as the magnetic recording medium of Example 1 except that the underlayer of the leader tape was formed to have a final average thickness of 1.3 μm. Also for the magnetic recording medium of Example 2 thus obtained, the maximum step difference ΔT, the error rate, and the PES were each measured in the same manner as Example 1. The results are exhibited in Table 1.

### Example 3

A magnetic recording medium of Example 3 was produced in the same manner as the magnetic recording medium of Example 1 except that the underlayer of the leader tape was formed to have a final average thickness of 1.1 μm. Also for the magnetic recording medium of Example 3 thus obtained, the maximum step difference ΔT, the error rate, and the PES were each measured in the same manner as Example 1. The results are exhibited in Table 1.

### Comparative Example 1

A magnetic recording medium of Comparative Example 1 was produced in the same manner as the magnetic recording medium of Example 1 except that the length of the leader tape in the longitudinal direction was set to 900±30 mm. Also for the magnetic recording medium of Comparative Example 1 thus obtained, the maximum step difference ΔT, the error rate, and the PES were each measured in the same manner as Example 1. The results are exhibited in Table 1.

### Comparative Example 2

A magnetic recording medium of Comparative Example 2 was produced in the same manner as the magnetic recording medium of Comparative Example 1 except that the underlayer of the leader tape was formed to have a final average thickness of 1.3 μm. Also for the magnetic recording medium of Comparative Example 2 thus obtained, the maximum step difference ΔT, the error rate, and the PES were each measured in the same manner as Example 1. The results are exhibited in Table 1.

### Comparative Example 3

A magnetic recording medium of Comparative Example 3 was produced in the same manner as the magnetic recording medium of Comparative Example 1 except that the underlayer of the leader tape was formed to have a final average thickness of 1.1 μm. Also for the magnetic recording medium of Comparative Example 3 thus obtained, the maximum step difference ΔT, the error rate, and the PES were each measured in the same manner as Example 1. The results are exhibited in Table 1.

### [Evaluation]

As illustrated in Table 1, in Examples 1 to 3, the maximum step difference ΔT of the stepped part at a position closest to the coupling part 4, i.e., at a position of 4.4 m from the beginning of the leader tape and 0.1 m from the coupling part 4 toward the beginning of the leader tape is 34 μm or less. Meanwhile, in Comparative Examples 1 to 3, the maximum step difference ΔT of the stepped part at a position closest to the coupling part 4, i.e., at a position of 0.8 m from the beginning of the leader tape is 39 μm or less. Accordingly, Examples 1 to 3 obtained better results than Comparative Examples 1 to 3 both in the error rate and the PES. That is, it was confirmed that, setting the maximum step difference of the stepped part at a position closest to the coupling part of the leader tape to the magnetic recording tape to 34 μm or less in the thickness direction of the leader tape made it possible to reduce bending, depression, or the like transferred onto the surface of the magnetic recording tape. As a result, it was confirmed to be possible to favorably perform the above without hindering the information recording operation on the magnetic recording tape or the information reading operation from the magnetic recording tape.

Although the specific description has been given of the present disclosure with reference to the embodiments and modification examples thereof, the present disclosure is not limited to the embodiments and the like described above, and may be modified in a wide variety of ways.

For example, the configurations, methods, processes, shapes, materials, numerical values, and the like described in the above embodiments and modification examples thereof are merely examples, and different configurations, methods, processes, shapes, materials, numerical values, and the like may be used, as needed. Specifically, the magnetic recording medium of the present disclosure may include components other than the substrate, the underlayer, the magnetic layer, the back layer, and the barrier layer. In addition, the chemical formulae of the compounds or the like are representative examples, and are not limited to the valences and the like described above as long as the compounds with the same general names are employed.

Further, the configurations, methods, processes, shapes, materials, numerical values, and the like of the above-described embodiments and modification examples thereof may be combined with each other without departing from the spirit of the present disclosure.

Further, in the numerical value ranges described in stages herein, the upper limit value or the lower limit value of the numerical value range in any stage may be replaced with the upper limit value or the lower limit value of the numerical value range in another stage. Unless otherwise specified, the materials exemplified herein may be used alone, or two or more thereof may be used in combination.

As described above, according to the magnetic recording medium of an embodiment of the present disclosure, the maximum step difference of the stepped part at a position closest to the coupling part between the leader tape and the magnetic recording tape, among the plurality of stepped parts generated on the leader tape after traveling in accordance with predetermined conditions 1 to 3, is configured to be 34 μm or less. It is therefore possible to favorably perform the above without hindering the information recording operation on the magnetic recording tape or the information reading operation from the magnetic recording tape.

It is to be noted that the effects of the present disclosure are not limited thereto, and may be any of the effects described herein. In addition, the present technology may have the following configurations.

(1)

A magnetic recording medium including:
a magnetic recording tape extending in a longitudinal direction; and
a leader tape coupled to the magnetic recording tape in the longitudinal direction, in which
a maximum step difference of a stepped part at a position closest to a coupling part between the leader tape and the magnetic recording tape, among a plurality of the stepped parts generated on the leader tape after traveling, is 34 μm or less in a thickness direction of the leader tape, the traveling being performed in accordance with the following conditions 1 to 3:
   condition 1: being in an environment of a temperature of 23° C. and a relative humidity of 45% RH;
   condition 2: using a drive pursuant to a standard of LTO 9; and
   condition 3: performing reciprocating traveling 140 times to record and reproduce a capacity of 18 terabytes.
   (2)

The magnetic recording medium according to (1), further including a splicing tape provided at the coupling part, in which the leader tape and the magnetic recording tape are coupled to each other by the splicing tape.

(3)

The magnetic recording medium according to (2), in which an average thickness of the leader tape and an average thickness of the magnetic recording tape are both thinner than an average thickness of the splicing tape.

(4)

The magnetic recording medium according to (3), in which the average thickness of the splicing tape is 5 μm or more and 24 μm or less.

(5)

The magnetic recording medium according to (3) or (4), in which the average thickness of the leader tape is thicker than the average thickness of the magnetic recording tape.

(6)

The magnetic recording medium according to (5), in which
the average thickness of the leader tape is 5.0 μm or more and 18.0 μm or less, and
the average thickness of the magnetic recording tape is 5.2±0.3 μm.
   (7)

The magnetic recording medium according to (6), in which a length of the leader tape is 4500 mm or less.

(8)

The magnetic recording medium according to any one of (1) to (7), in which a dimensional change amount Δw of the magnetic recording tape in a width direction with respect to a tensional change in the longitudinal direction is represented by 700 [ppm/N] ≤Δw.

(9)

A magnetic recording medium cartridge including:
a reel;
a tape-like magnetic recording medium wound around the reel; and
a housing that accommodates the magnetic recording medium,
the magnetic recording medium including
   a magnetic recording tape extending in a longitudinal direction, and
   a leader tape coupled to the magnetic recording tape in the longitudinal direction, in which
a maximum step difference of a stepped part at a position closest to a coupling part between the leader tape and the magnetic recording tape, among a plurality of the stepped parts generated on the leader tape after traveling, is 34 μm or less in a thickness direction of the leader tape, the traveling being performed in accordance with the following conditions 1 to 3:
   condition 1: being in an environment of a temperature of 23° C. and a relative humidity of 45% RH;
   condition 2: using a drive pursuant to a standard of LTO 9; and
   condition 3: performing reciprocating traveling 140 times to record and reproduce a capacity of 18 terabytes.

This application claims the benefit of Japanese Priority Patent Application JP2021-130332 filed with the Japan Patent Office on Aug. 6, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A magnetic recording medium comprising:
a magnetic recording tape extending in a longitudinal direction; and
a leader tape coupled to the magnetic recording tape in the longitudinal direction, wherein
a maximum step difference of a stepped part at a position closest to a coupling part between the leader tape and the magnetic recording tape, among a plurality of the stepped parts generated on the leader tape after traveling, is 34 μm or less in a thickness direction of the leader tape, the traveling being performed in accordance with the following conditions 1 to 3:
condition 1: being in an environment of a temperature of 23° C. and a relative humidity of 45% RH;
condition 2: using a drive pursuant to a standard of LTO 9; and
condition 3: performing reciprocating traveling 140 times to record and reproduce a capacity of 18 terabytes.

2. The magnetic recording medium according to claim 1, further comprising a splicing tape provided at the coupling part, wherein the leader tape and the magnetic recording tape are coupled to each other by the splicing tape.

3. The magnetic recording medium according to claim 2, wherein an average thickness of the leader tape and an average thickness of the magnetic recording tape are both thinner than an average thickness of the splicing tape.

4. The magnetic recording medium according to claim 3, wherein the average thickness of the splicing tape is 5 μm or more and 24 μm or less.

5. The magnetic recording medium according to claim 3, wherein the average thickness of the leader tape is thicker than the average thickness of the magnetic recording tape.

6. The magnetic recording medium according to claim 5, wherein
the average thickness of the leader tape is 5.0 μm or more and 18.0 μm or less, and
the average thickness of the magnetic recording tape is 5.2±0.3 μm.

7. The magnetic recording medium according to claim 6, wherein a length of the leader tape is 4500 mm or less.

8. The magnetic recording medium according to claim 1, wherein a dimensional change amount Δw of the magnetic recording tape in a width direction with respect to a tensional change in the longitudinal direction is represented by 700 [ppm/N]≤Δw.

9. A magnetic recording medium cartridge comprising:
a reel;
a tape-like magnetic recording medium wound around the reel; and
a housing that accommodates the magnetic recording medium,
the magnetic recording medium including
a magnetic recording tape extending in a longitudinal direction, and
a leader tape coupled to the magnetic recording tape in the longitudinal direction, wherein
a maximum step difference of a stepped part at a position closest to a coupling part between the leader tape and the magnetic recording tape, among a plurality of the stepped parts generated on the leader tape after traveling, is 34 μm or less in a thickness direction of the leader tape, the traveling being performed in accordance with the following conditions 1 to 3:
condition 1: being in an environment of a temperature of 23° C. and a relative humidity of 45% RH;
condition 2: using a drive pursuant to a standard of LTO 9; and
condition 3: performing reciprocating traveling 140 times to record and reproduce a capacity of 18 terabytes.
